(19) United States
(12) Patent Application Publication
(10) Pub. No.: US 2007/0073584 A1
(43) Pub. Date: Mar. 29, 2007

(54) Systems and Methods For Media Planning, Ad Production, and Ad Placement For Internet

(75) Inventors: Nicholas A. Grouf, Los Angeles, CA (US); Lucy Ann Lieberman, Venice, CA (US); Max Metral, Boston, MA (US); Svein Rorvik, San Clemente, CA (US); David Waxman, Los Angeles, CA (US); John Hastings Granbery, Boston, MA (US)

Correspondence Address: WILSON SONSINI GOODRICH & ROSATI, 650 PAGE MILL ROAD, PALO ALTO, CA, 94304-1050, US

(73) Assignee: Spot Runner, Inc., a Delaware Corporation, small business concern

(21) Appl. No.: 11/467,126

(22) Filed: Aug. 24, 2006

Related U.S. Application Data
(60) Provisional application No. 60/711,777, filed on Aug. 26, 2005.
(60) Provisional application No. 60/711,833, filed on Aug. 26, 2005.
(60) Provisional application No. 60/711,717, filed on Aug. 26, 2005.
(60) Provisional application No. 60/711,820, filed on Aug. 26, 2005.
(60) Provisional application No. 60/711,821, filed on Aug. 26, 2005.
(60) Provisional application No. 60/711,719, filed on Aug. 26, 2005.
(60) Provisional application No. 60/711,774, filed on Aug. 26, 2005.

(51) Int. Cl. G06Q 30/00

(52) U.S. Cl. 705/14

(57) ABSTRACT

Methods and systems for generating an on-line media plan for an on-line advertiser. The approach may include storing information regarding advertising rates of a plurality of on-line media properties; storing information regarding on-line audience reached by the on-line media properties; storing information regarding the on-line advertiser; generating a media plan for on-line advertisements based on the advertising rates, information regarding on-line audience, the information regarding the on-line advertiser; and presenting the media plan to the on-line advertiser for purchase. The advertisement may include an advertisement placed on a web site, an advertisement sent by e mail, a rich media advertisement, or a click through advertisement.

This application claims the benefit of U.S. Provisional Applications Nos. 60/711,777 filed Aug. 26, 2005, 60/711,833 filed Aug. 26, 2005, 60/711,717 filed Aug. 26, 2005, 60/711,820 filed Aug. 26, 2005, 60/711,821 filed Aug. 26, 2005, 60/711,719 filed Aug. 26, 2005, and 60/711,774 filed Aug. 26, 2005, each of which is incorporated herein by reference in its entirety.

### CROSS REFERENCE TO RELATED APPLICATIONS

All publications and patent applications mentioned in this specification are herein incorporated by reference to the same extent as if each individual publication or patent application was specifically and individually indicated to be incorporated by reference.

This application is related to the following co-pending applications, each of which is incorporated herein by reference: application Ser. No.______, (Attorney Docket No. 31944.701.201) for Systems and Methods For Media Planning, Ad Production, and Ad Placement, invented by Nicholas A. Grouf, Lucy Ann Lieberman, Max Metral, Svein Rorvik, David Waxman, and John Hastings Granbery, filed concurrently herewith; qpplication Ser. No. ______, (Attorney Docket No. 31944.701.202) for Systems and Methods For Content Customization, invented by Nicholas A. Grouf, Lucy Ann Lieberman, Max Metral, Svein Rorvik, David Waxman and John Hastings Granbery filed concurrently herewith; application Ser. No.______, (Attorney Docket No. 31944.701.203) for Systems and Methods For Media Planning, Ad Production, and Ad Placement For Television, invented by Nicholas A. Grouf, Lucy Ann Lieberman, Max Metral, Svein Rorvik, David Waxman and John Hastings Granbery, filed concurrently herewith; application Ser. No.______, (Attorney Docket No. 31944.701.204) for Systems and Methods For Media Planning, Ad Production, and Ad Placement For Radio, invented by Nicholas A. Grouf, Lucy Ann Lieberman, Max Metral, Svein Rorvik, David Waxman and John Hastings Granbery, filed concurrently herewith; application Ser. No. ______, (Attorney Docket No. 31944.701.206) for Systems and Methods For Media Planning, Ad Production, and Ad Placement For Print, invented by Nicholas A. Grouf, Lucy Ann Lieberman, Max Metral, Svein Rorvik, David Waxman and John Hastings Granbery, filed concurrently herewith; application Ser. No.______, (Attorney Docket No. 31944.701.207) for Systems and Methods For Media Planning, Ad Production, and Ad Placement For Out-Of-Home Media, invented by Nicholas A. Grouf, Lucy Ann Lieberman, Max Metral, Svein Rorvik, David Waxman, and John Hastings Granbery, filed concurrently herewith and PCT Application No.: _____ (Attorney Docket No. 31944.701.601) for Systems and Methods for Media Planning, Ad Production, Ad Placement and Content Customization invented by Nicholas A. Grouf; Lucy Ann Lieberman; Max Metral; Svein Rorvik, David Waxman, and John Hastings Granbery, filed concurrently herewith.

### BACKGROUND

The development of advertising campaigns and the production of Internet advertisements is often done on an ad hoc basis by advertising agencies and may be expensive and time consuming.

There is a demand for content for various Internet applications. For example, Internet advertisements played use content to promote the respective products or services. Producing the content for the respective users, such as Internet advertisers can be expensive.

### SUMMARY OF THE DISCLOSURE

Various embodiments of the invention provide systems or methods for better developing media plans for Internet advertisers as well as customized Internet advertisements that may be placed as part of such media plan. Other embodiments of the invention provide systems or methods of creating customized Internet content based on user input. The customized content can be used in advertisements or in other applications.

A better understanding of the features and advantages of the present invention will be obtained by reference to the following detailed description that sets forth illustrative embodiments.

This summary provides illustrative information regarding the disclosure and is not intended to limit the claimed invention.

### DETAILED DESCRIPTION

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

According to various embodiments, the advertisements described herein include any of the following, individually or in any combination: commercials, which may include television commercials (including terrestrial broadcast, cable, satellite, closed circuit systems or other transmission or viewing) and/or radio commercials (terrestrial, short-wave, long-wave, satellite-delivered, or delivered through any other mode or method of radio transmission); advertisements meant for delivery on or through the Internet in any of or any combination of various forms or formats including websites, rich media applications, e-mail, and banner ads; print advertisements which are to be published in, for instance, any of or any combination of magazines, newspapers, newspaper-delivered-magazines, directory listings and/or direct mail; out-of-home advertisements placed in various venues, including, any or any combination of billboards, theaters, cinema, restaurants and bars, elevators, transit systems, and other spaces for placement of out-of-home advertisements.

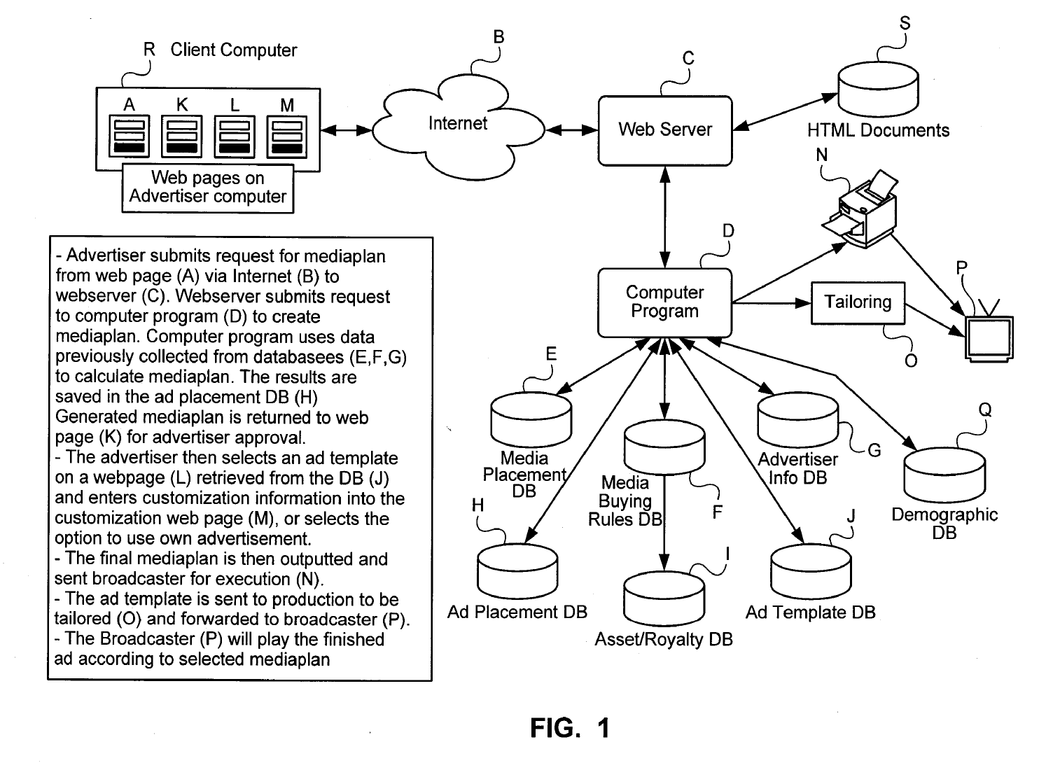

FIG. 1 is a logical block diagram illustrating a system according to an embodiment of the present invention, including one or more client computers R through which an advertiser may develop and purchase a media plan and generate and purchase customized advertisements for placement as part of such media plan.

The client computer R may include a web browser, such as Microsoft Internet Explorer, or other client software for displaying web pages (A, K, L and M) or other interface for interacting with a server. The client computer communicates with a web server C over a network, such as Internet B or some other network such as a local area network (LAN) or intranet. FIG. 1 shows several elements (D, E, F, G, H, I, J, N, Q and S) as separate items, although it will be understood that these items may all be part of the web server system C or may be distributed over other computers and storage systems and accessed by web server C over a local area network (LAN) or other network. These elements include computer programs D which include the software instructions executed by web server C, databases (E, F, G, H, I, J and Q), fax or printer or other peripheral communication device N, and HTML documents S.

The following is an example method used in connection with the system of FIG. 1 to develop and purchase a media plan, customize and purchase ads and place the ads in accordance with the media plan. The web server provides a web site that acts as an interface for customers using a client computer, such as an advertiser. The web pages are served by web server C from a directory of HTML documents S on storage connected to the web server. The advertiser submits a request for a media plan from web page A via Internet B to web server C. The web server submits a request to computer program D to create a media plan.

The media plan may be a plan for placing advertisements that target certain demographics, based on industry selections or direct selection of target demographics by the advertiser as well as plan objective, duration and budget information provider by the advertiser.

The advertisements and plans may take the form of the respective media described herein such as television, radio, Internet, print, out-of-home, etc. In an embodiment, the system tracks inventory in respective different media separately and uses the information regarding the respective media in determining ideal performance of media to optimize performance of the respective media plan. In an embodiment of the invention, the system takes into account audience information and information regarding the respective media in generating an optimal media plan. For example, according to one embodiment of the invention, the system compares possible performance in different respective media for the respective target market of the user and generates a media plan that uses media that perform better for the respective target market.

The media plan includes, in various combinations, a list of any stations (television and/or radio stations), publications, venues, Internet modes of advertisement, dates the ads will run, part of the day during which the ad will run, rate per ad, the market in which the ad will run, type of schedule (e.g., run of schedule or fixed), number of airings and total cost for each portion of the media plan, as appropriate for the respective media.

The computer program uses data from media placement database E, media buying rules database F and advertiser info database G to generate the media plan. For instance, the databases may store information regarding the Multiple System Operators (MSOs) in Designated Market Areas (DMAs), Regions, Zones and/or Head Ends, including audience information and rate cards specifying channels offered by the MSO, pricing tiers, and the costs for running ads on those channels during various parts of the day (time slots) for each channel. According to various embodiments, audience information includes one or any combination of: ratings (e.g., Nielsen ratings) as well as other audience information such as demographic, lifestyle, and brand/user volume information and profiles (e.g., data from sources such as MediaMark Research Inc. “MRI”), data relating to one of or any combination of: audiences' leisure interests, use of technology, brand preferences, amounts spent on different products and services, and/or other demographic data emanating from a variety of other sources, services, or inputs (e.g. U.S. Census Data). According to some embodiments of the invention, the respective audience information is categorized and/or used for respective channels according to demographic categories (e.g., age groups, gender, households, etc.). In an example embodiment, the computer program will generate a media plan based on this information as well as other data (e.g., cost to reach target demographic and/or price per point data) that will provide advertisements in one or more media consistent with the user specified objective of the media plan and will select the media (e.g., television, radio, internet, print, out of home or other) and various attributes of the media (e.g., channels, times of day, venue, etc. as applicable) reaching the target demographic within the specified budget (based on the rate information, ratings and audience information). Rankings of respective media and/or types of advertisements are provided per price point (and/or budget) according to an embodiment of the invention.

An embodiment of the invention is directed to generation of a media plan for television. The media plan includes a list of television stations, dates the ads will run, part of the day during which the ad will run, rate per ad, the market in which the ad will run, type of schedule (e.g., run of schedule or fixed), number of airings and total cost for each portion of the media plan. According to an embodiment of the invention, the system of FIG. 1 to develop and purchase a media plan for television, customize and purchase television ads and place the ads in accordance with the media plan. The web server provides a web site that acts as an interface for television advertisement customers using a client computer. The television advertiser submits a request for a media plan from web page A via Internet B to web server C. The web server submits a request to computer program D to create a media plan for television. In an example embodiment, the media plan may be a plan for placing commercials on television that target certain demographics, based on industry selections or direct selection of target demographics by the advertiser as well as plan objective, duration and budget information provider by the advertiser. The media plan may be a list of television stations, dates the ads will run, part of the day during which the ad will run, rate per ad, the market in which the ad will run, type of schedule (e.g., run of schedule or fixed), number of airings and total cost for each portion of the media plan. The computer program uses data from media placement database E, media buying rules database F and advertiser info database G to generate the media plan. For instance, the databases may store information regarding the Multiple System Operators (MSOs) in Designated Market Areas (DMAs), Regions, Zones and/or Head Ends, including ratings information (e.g., Nielsen ratings) for each channel within various demographic categories (e.g., by age groups, gender, households, etc.) and rate cards specifying tiers of channels offered by the MSO and the costs for running ads on those channels during various part of the day (time slots) for each channel. In an example embodiment, the computer program will generate a media plan for television based on this information as well as other data (e.g., cost to reach target demographic and/or price per point data) that will provide a number of spots consistent with the user specified objective of the media plan and will select the channels and day parts reaching the target demographic that allows the desired number of spots to be purchased within the specified budget (based on the rate card information, ratings and audience information).

Embodiments of the invention may include application to radio advertising (including terrestrial radio and subscriber and non-subscriber based satellite radio advertising) sold by stations, services or third parties within a DMA as syndicated national programming (similar to national broadcast TV) or spot market programming (similar to spot market broadcast TV). Embodiments may be applied in syndicated programming sold locally or nationally, or spot market programming sold locally. Embodiments may be applied to advertising purchased by individual stations or through a company that sells multiple stations, and to advertising that is purchased based on day of week and/or day part, and/or based on specific programming, in any combination. According to an embodiment, the selection of day and day part targets specific audiences defined by demographic (e.g., age, gender, etc.) and/or psychographic variables (e.g., lifestyle or interest choices) which the advertiser would like to reach.

In an embodiment with radio advertisements, the databases may store information regarding radio stations by DMAs, broken down by specific regions, zones, head ends or areas, including ratings information (e.g., employing third party measurement services or tools) for each channel within various demographic categories (e.g., by age groups, gender, households, etc.) and rate cards specifying pricing tiers from the radio operator or station owner and the costs for running ads on those radio stations during various part of the day (time slots). In an example embodiment, the computer program will generate a media plan based on this information as well as other data (e.g., cost to reach target demographic and/or price per point data) that will provide a number of spots consistent with the user specified objective of the media plan and will select radio stations reaching the target demographic that allows the desired spots to be purchased within the specified budget (based on the rate information, ratings and audience information).

Embodiments of the invention may include application to online media purchased nationally, and/or purchased or targeted locally along a DMA, region, and zone type-model. Embodiments of the invention may include application to online media advertising sold based on content of the site and advertisers select sites that reach their desired customers. According to various embodiments pricing for the online media is based on the type of ad (banner, paid search, rich media), number of impressions of the ad, click-through on the ad, and/or on the viewer taking a pre-defined action.

In an embodiment with Internet advertisements, the media plan may include web site or list of websites on which the ads are placed or e-mail addresses to which the advertisements will be sent, dates the ads will be posted on the web or sent to an e-mail list, rate per ad based on the type of ad (e.g., rich media, banner ad, e-mail, streaming clip on a third party website, pop-up ad, click-through ad), the market in which the ad will run, websites on which the ad will run, length of time the ad will run, frequency with which the ad appears in a given amount of time, total number of airings and total cost for each portion of the media plan. The computer program uses data specific to online media from media placement database E, media buying rules database F and advertiser info database G to generate the media plan. For instance, the databases may store information regarding websites as nationally functioning concerns or by DMAs, broken down by specific regions, zones, or smaller areas, including measurement information (e.g., employing third party measurement services or tools) for each online form of advertising within various demographic categories (e.g., by age groups, gender, households, etc.) and rate information specifying pricing and the costs for running ads on those online forms of advertising during various parts of the day (time slots) if applicable. The database may store other information about various channels of online advertising, including e-mail lists and other web-based marketing solutions. In an example embodiment, the computer program will generate a media plan based on this information as well as other data (e.g., cost to reach target demographic and/or price per point data) that will provide a number of advertisements consistent with the user specified objective of the media plan and will select the online forms of advertising (e.g., e-mail, banner, rich media, pop-up, etc.) reaching the target demographic that allows the desired number of ads to be purchased within the specified budget (based on the rate information, ratings and audience information). According to an embodiment, the selection is based on the factors listed herein including various combinations of ratings, audience information, etc.

Embodiments of the invention include using audience measurement (e.g., number of users and demographics) for Internet sites through third party measurement tools, or other measurement including in an embodiment measuring efficacy for Internet advertising on the advertiser's website by the number of visitors or sales and/or other transactions the advertiser is able to achieve from viewers clicking on a link in the ad.

In an embodiment with print advertisements, the media plan may include one of the following categories or any combination of: print publications purchased nationally, regionally, or locally, directory lists, direct mail and other forms of print on which the advertisements will be placed. An embodiment includes placement of print advertisements in national magazines and/or such or other print media purchased in smaller geographies and/or circulated within a limited geography. Print advertising may be used, such as print advertising sold based on the circulation of the publication, demographics of the reader, and the content of the publication. Audience circulation and other publication information are accomplished through third party measurement tools.

In an embodiment with print advertisements, the media plan may include one of the following categories or any combination of the following or other print media described herein: newspapers including local or regional circulations and/or national publications (e.g., USA Today, Time Magazine, etc.). Embodiments may include use of advertising sold based on placement within the magazine or paper, size of the ad, and use of color. Embodiments may include use of information regarding audience circulation and other publication information through third party measurement tools.

The media plan may include a list of print publications, magazines and/or newspapers, directory lists, direct mail and other forms of print, dates the ads will run including for example, issue number, volume number, rate per ad, the market in which the ad will run, number of issues in which the ad will run, and total cost for each portion of the media plan. The computer program uses data specific to print publications from media placement database E, media buying rules database F and advertiser info database G to generate the media plan. For instance, the databases may store information regarding print publications by niche, market segment, geography, broken down by specific regions, zones, or smaller areas, including audience information (e.g., employing third party measurement services or tools) for each segment within various demographic categories (e.g., by age groups, gender, households, etc.) and rate information specifying pricing tiers and the costs for running ads on those magazines or newspapers.

In an embodiment for out-of-home media advertisements, the media plan may include any configuration of national, regional, or local out-of-home media advertisements. Such advertisements may include local media and/or billboards, transit exteriors, in-store and other venue placement, videos, skywriting, etc. Embodiments may include plans in which such advertisements are sold based on showings, the percent of individuals in a given market who were exposed to that media. Information on showings may be measured and provided by third parties. That information may be integrated into the media placement database according to an embodiment.

The media plan for out-of-home media advertisements may be a list of venues, dates the ads will run, rate per ad per venue, the market in which the ad will run, and total cost for each portion of the media plan. The computer program uses data specific to out-of-home media from media placement database E, media buying rules database F and advertiser info database G to generate the media plan. For instance, the databases may store information regarding out-of-home venues by DMAs, broken down by specific regions, zones, head ends or areas, including ratings information (e.g., employing third party measurement services or tools) for each venue within various demographic categories (e.g., by age groups, gender, households, etc.) and rate cards specifying various out-of-home venues, and the costs for posting ads on those venues. In an example embodiment, the computer program will generate a media plan based on this information as well as other data (e.g., cost to reach target demographic and/or price per point data) that will provide a number of advertisements consistent with the user specified objective of the media plan and will select the venues reaching the target demographic that allows the desired number of ads to be purchased within the specified budget (based on the rate information, ratings and audience information).

According to an embodiment, the advertiser may also browse and select a template on web page L retrieved from ad template database J and enter customization information into a customization web page M or may select an option to use its own advertisement (which can be uploaded to ad placement database H).

The resulting media plan is stored in ad placement database H. The generated media plan is displayed to the advertiser for editing/approval via web page K. The advertiser may edit, save and/or purchase the media plan.

The approved media plan and customized ad are sent to the media property or properties, such as broadcaster, publication, web site, or displaying venue or distributor of advertisements as shown at P (via email, fax, web page, or other means). The ad may be sent in one or a combination of media or transmission methods, for example, digitally or via some other media which may include tape (DigiBeta, Beta SP, ¾″, or other form) or other media. The media property, such as broadcaster, publication, web site or displaying venue or distributor of advertisements, attempts to play and/or display the finished ad in accordance with the media plan. The advertiser may be charged by using credit card information or other payment form in advertiser info database G. Royalty information for each object in the finished ad may be stored in Asset/Royalty database I. Computer program may use this information to automatically calculate and pay royalties for the ad, which may be used for any of the following or combination of: video, music, sound effects, stills, graphics, text, special effects and/or other media objects used in the advertisement.

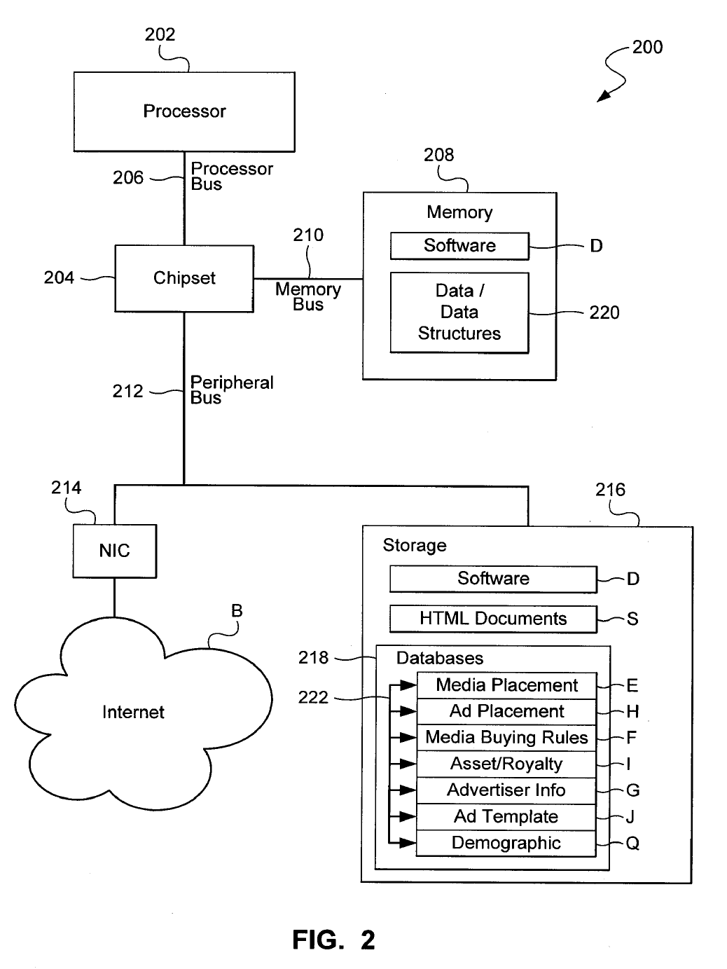

FIG. 2 is a block diagram showing the architecture of a web server system, generally indicated at 200, according to an embodiment of the present invention. As shown in the example embodiment of FIG. 2, the web server system may include a processor 202 for processing instructions, such as a Intel Pentium™ processor, AMD Athlon™ processor or other processor. The processor 202 is connected to a chipset 204 by a processor bus 206. The chipset 204 is connected to random access memory (RAM) 208 by a memory bus 210 and manages access to the RAM 208 by the processor 202. The chipset is also connected to a peripheral bus 212. The peripheral bus may be, for example, PCI, PCI-X, PCI Express or other peripheral bus. The web server system 200 also includes one or more network interface cards (NICs) 214 connected to the peripheral bus for providing network interfaces to a network, such as Internet B. External storage 216, such as a disk array or other non-volatile storage, is also connected to peripheral bus 212.

Software D, databases 218 and HTML documents S are stored in external storage 216 or other computer readable medium and may be loaded into RAM 208 for use by the processor. Portions of data from databases 218 may be loaded into data structures 220 in memory 208 or other computer readable medium for manipulation by the processor 202 in accordance with software D. The web server 200 includes an operating system for managing system resources, such as Microsoft Windows NT, Linux or other operating system, as well as application software running on top of the operating system for implementing the HTML server, media plan generation application and ad template customization application. As shown at 222, the databases may contain cross references or links to one another to allow information to be queried and retrieved. In an example embodiment, the databases may be relational databases and may be queried using standard query language (SQL) or other mechanism.

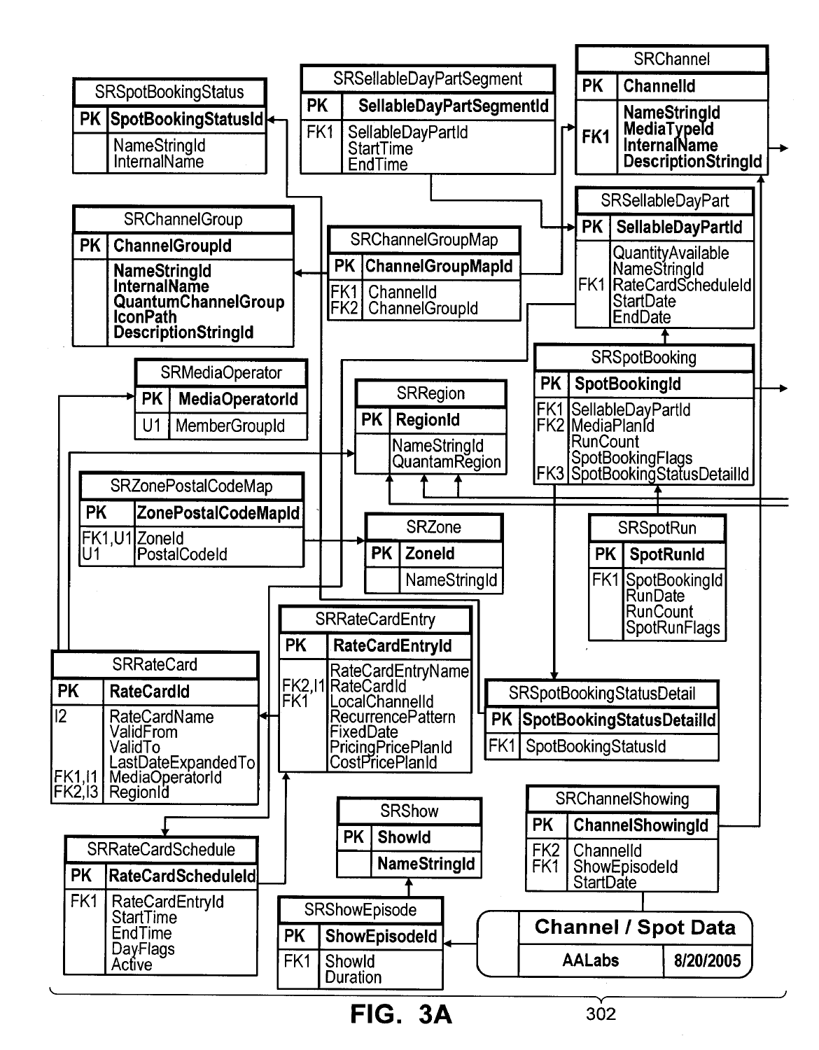

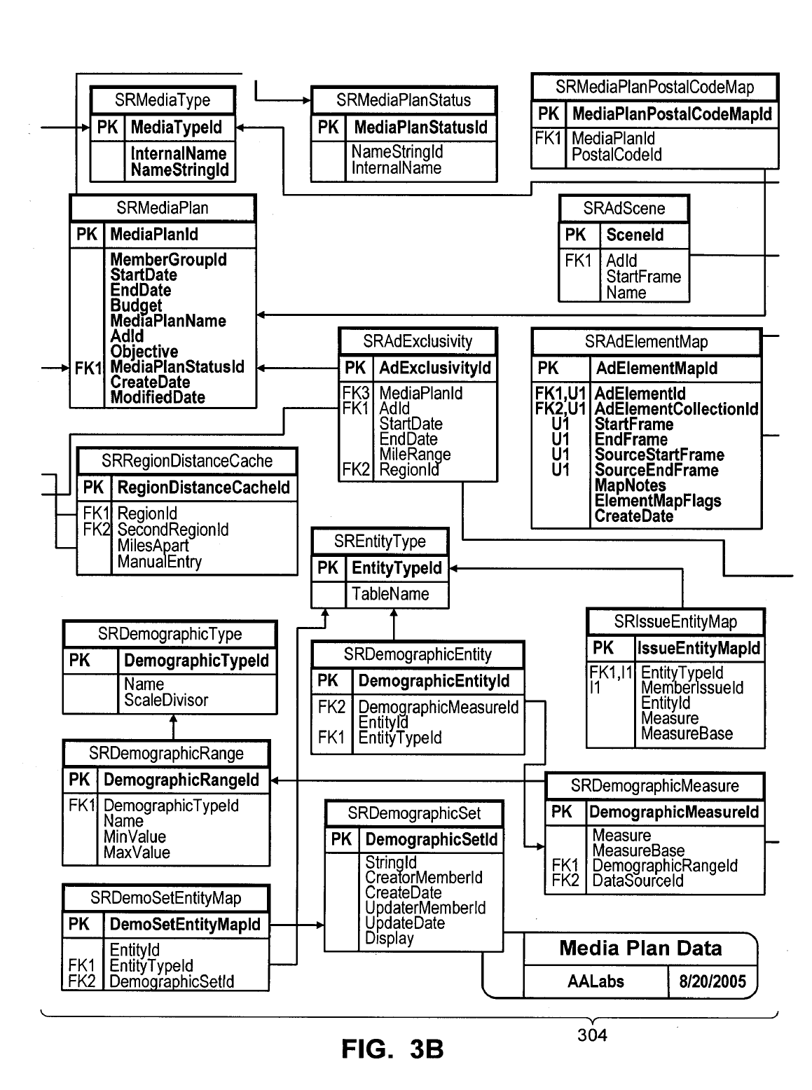

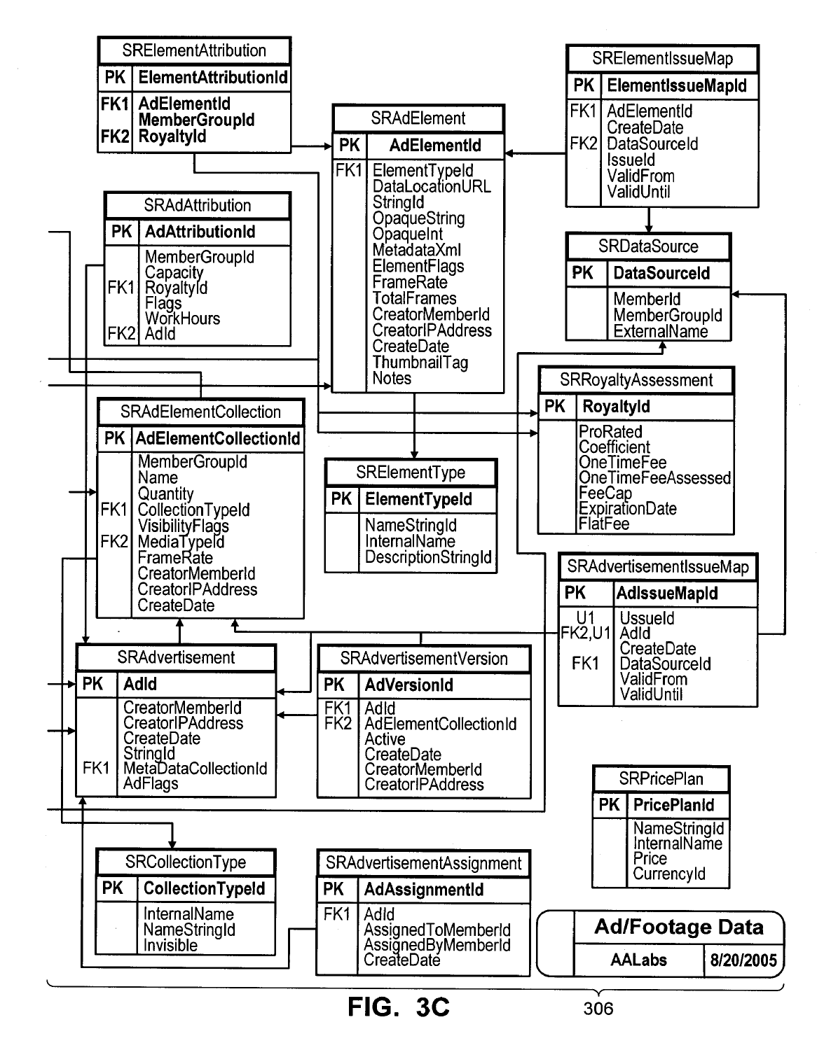

FIG. 3 is an example database schema that may be used in connection with an embodiment of the present invention. FIG. 3 shows sample tables and data entries for data stored in databases 218 and links among the various tables. The left group of tables stores channel/spot data 302, the middle group of tables stores media plan data 304 and the right group of tables stores ad/footage data 306.

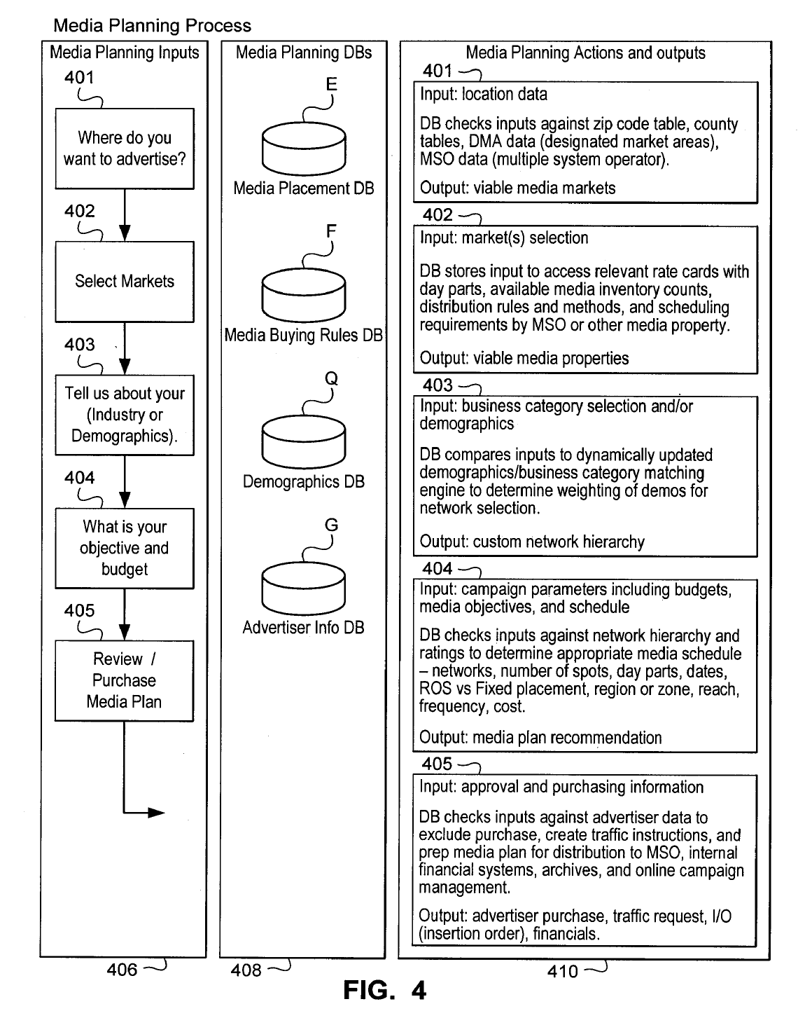

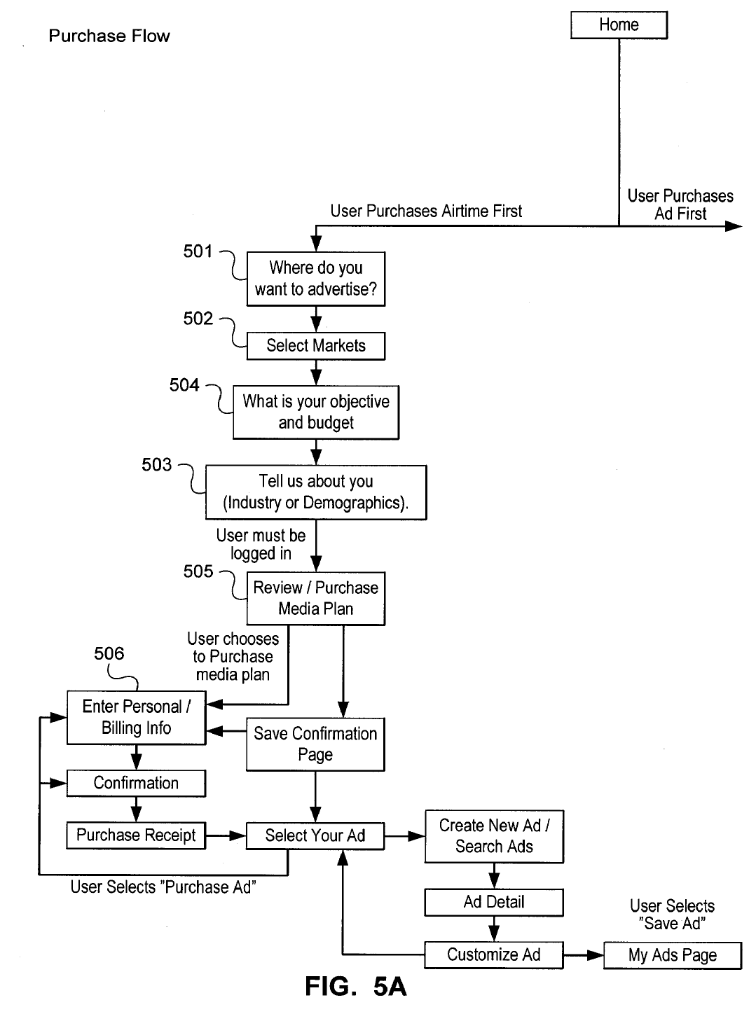

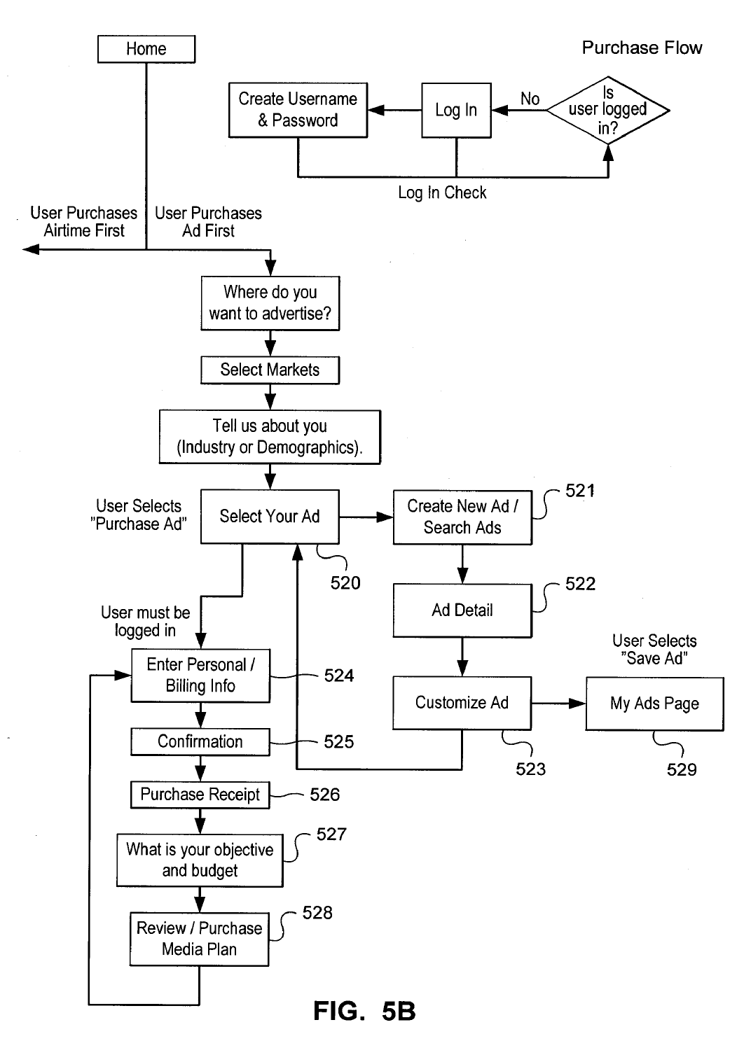

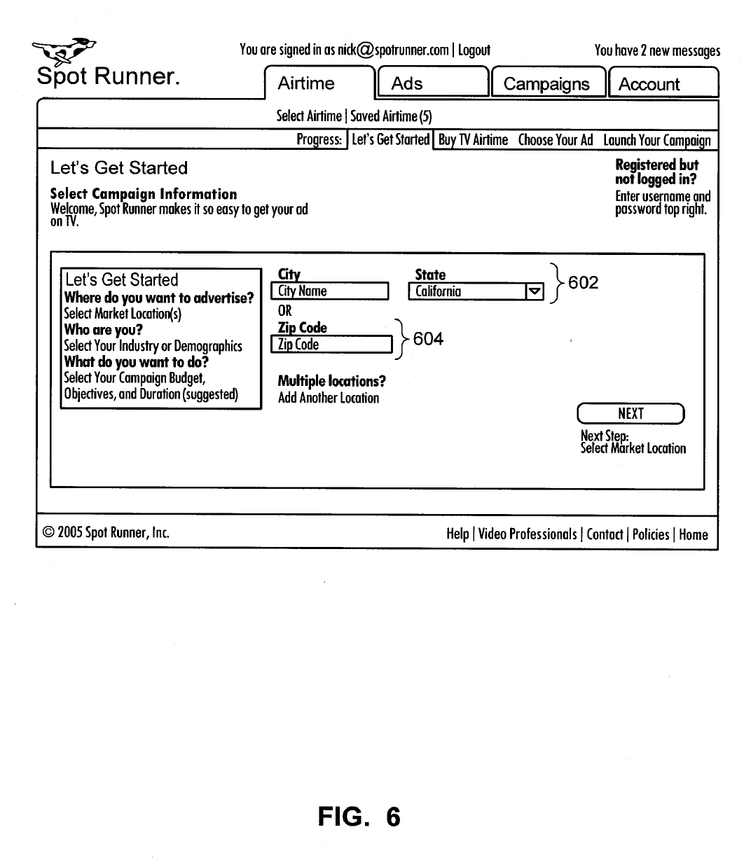

FIG. 4 shows an example flow chart for selecting and purchasing a media plan at 406, the databases used in this method at 408, and information regarding the inputs/outputs for each step in the method at 410. FIG. 5 shows a more detailed flow chart of a method for selecting and purchasing a media plan (and also includes steps for generating and purchasing a customized ad). FIGS. 6-14 show example screen shots of web pages that may be displayed on client computer R in connection with the method of selecting and purchasing a media plan as shown in FIGS. 4 and 5. An example method of selecting and purchasing a media plan will now be described with reference to these figures.

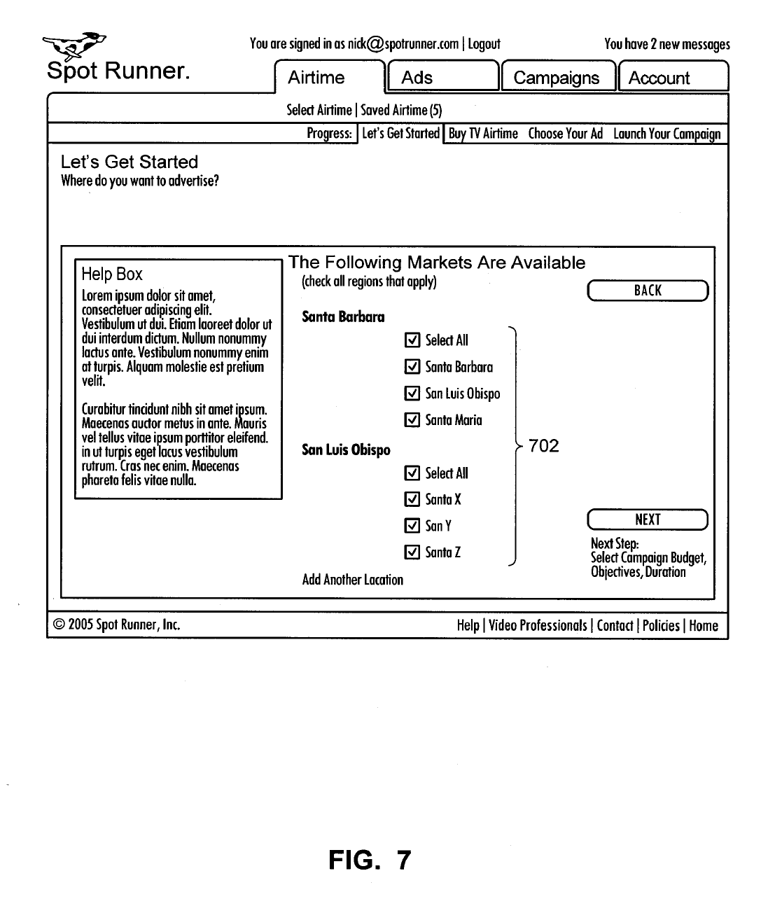

As shown at step 401 in FIG. 4, and step 501 in FIG. 5, a user is first asked where the user would like to advertise. An example web page for requesting this information is shown in FIG. 6. As shown in FIG. 6, a user may specify location by location information, which may be in the form of various combinations of city, state and/or country (see 602) or postal code (or country code) (see 604). The computer program D on the web server system 200 (see FIGS. 1 and 2) then uses the location information to query the media placement database E to determine the designated market areas (DMAs), regions, zones and head ends for the specified locations and the MSOs for the areas. Media placement database E may include a postal code table associating this information with postal codes and a city or county table associating this information with a city or county. The output from this step is a web page showing the available markets for the postal code or city entered by the user. FIG. 7 shows an example web page showing the available markets for the Santa Barbara/San Luis Obispo/Santa Maria DMA.

As shown at steps 402 in FIG. 4 and 502 in FIG. 5, the user may then select the desired markets. For example, check boxes as shown at 702 in FIG. 7 may be used for this purpose. As described at 402 in box 410, the selected markets may be used to look up rate cards, available media inventory counts, distribution rules and methods and scheduling requirements by the media property such as MSO, website, broadcaster, publisher, web site or venue or distributor of advertisements. For instance, media placement database E may include a media property table that associates this information with each media property and/or distributor. The database may be queried to determine all viable media properties and/or distributors that can be used in the media plan (based on the selected markets). This can be stored in a data structure in memory 208 or in one of the databases (such as advertiser info database G) for later use.

As shown at step 403 in FIG. 4 and 503 in FIG. 5, the user may then be asked to specify an industry or demographic information for the media plan. It will be understood that the order of various steps may be changed in different embodiments (as shown in FIG. 5, which has a different order than FIG. 4 for steps 503 and 504).

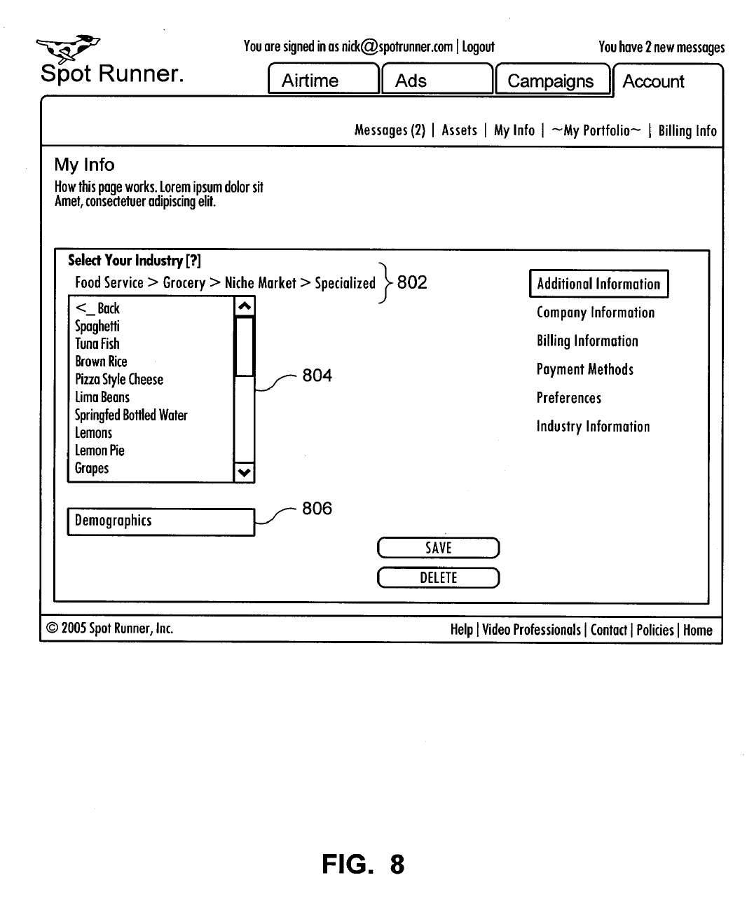

FIG. 8 shows a web page for requesting industry or demographic information. As shown at 804, a menu may be used to choose an industry. The menu may start with high level categories. After a category is selected, it may be shown at 802 in breadcrumb form. The menu 804 will then show choices within that category in a hierarchical fashion. In FIG. 8, the user has already selected “Food Service” as a top level category, then “Grocery,” “Niche Market” and “Specialized.” The menu 804 shows choices for products within the category “Specialized.”Various other industry categories may be specified hierarchically, such as Arts & Entertainment (which may have sub-categories such as “Clubs & Nightlife,” with sub-choices such as “Bars & Pubs” or “Karaoke Bars”). Other example categories may include “Automotive,” “Business and Professional Services,” “Clothing & Accessories,” “Community & Government,” “Computers & Electronics,” “Construction & Contractors,” “Education,” “Food & Dining,” “Health & Medicine,” “Home & Garden,” “Industry & Agriculture,” “Legal & Financial,” “Media & Communication,” “Personal Care & Services,” “Real Estate,” “Shopping,” “Sports & Recreation,” and “Travel & Transportation. ” Other industry categories and sub-categories may be used in other embodiments and may be cross referenced and cross listed and/or indexed in various ways.

The industry specified by the user can be used by computer program D to specify a target demographic. Each industry may be associated with target demographics in demographics database Q. The demographics may be determined by industry reports or other criteria. In other embodiments, the demographics may be modified based on the typical demographics selected by other users in the same industry. Alternatively, the user can input specific demographics by selecting button 806. The user can then input (into a dialog box or from a menu or other means) a target demographic for the media plan. The target demographic may be any category for which audience information is available (e.g., Nielsen rating categories). Exanples include age group (e.g., 18+, 12-24, 12-34, 18-34, etc.), gender (male or female), household characteristics (e.g. income, size, presence of children) and the like. The computer program D uses the demographic information to determine weightings for ranking the available media properties (e.g., networks/channels for available MSOs) (determined at step 402/502, which output the viable media properties). The computer program D then generates a ranked, custom hierarchy of networks from the available media properties in order of desirability given the target demographics and audience information (e.g., Nielsen ratings for the network or MRI information all stored in the media placement database E). This can be stored in a data structure in memory 208 or in databases 218 (such as advertiser info database G) for later use. The weightings and rankings of networks is described further below.

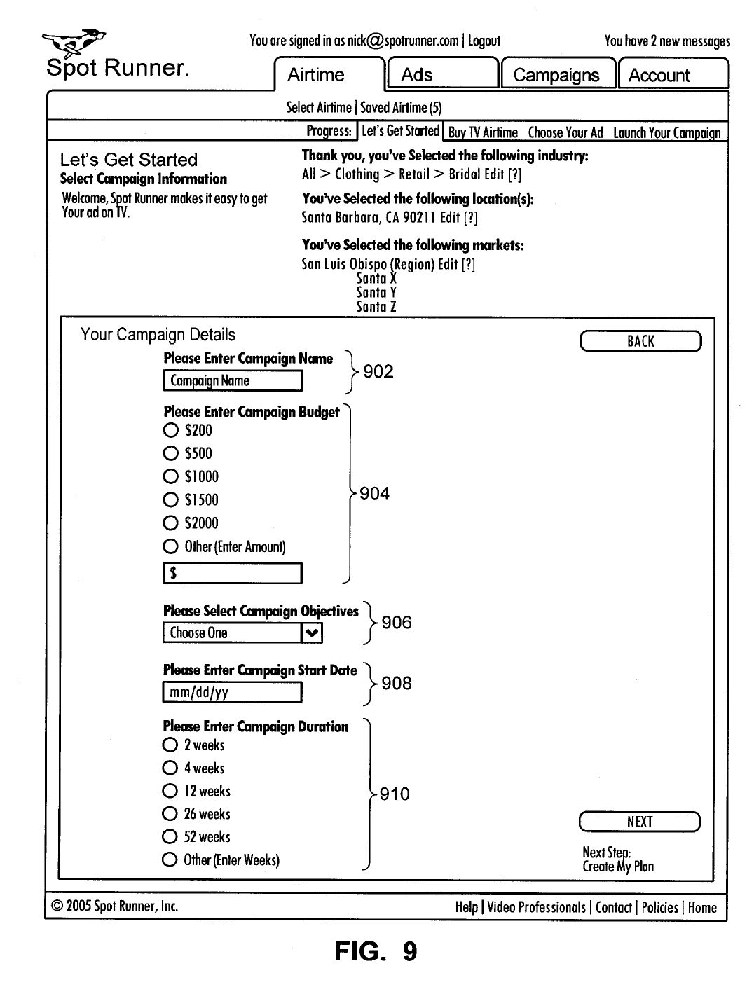

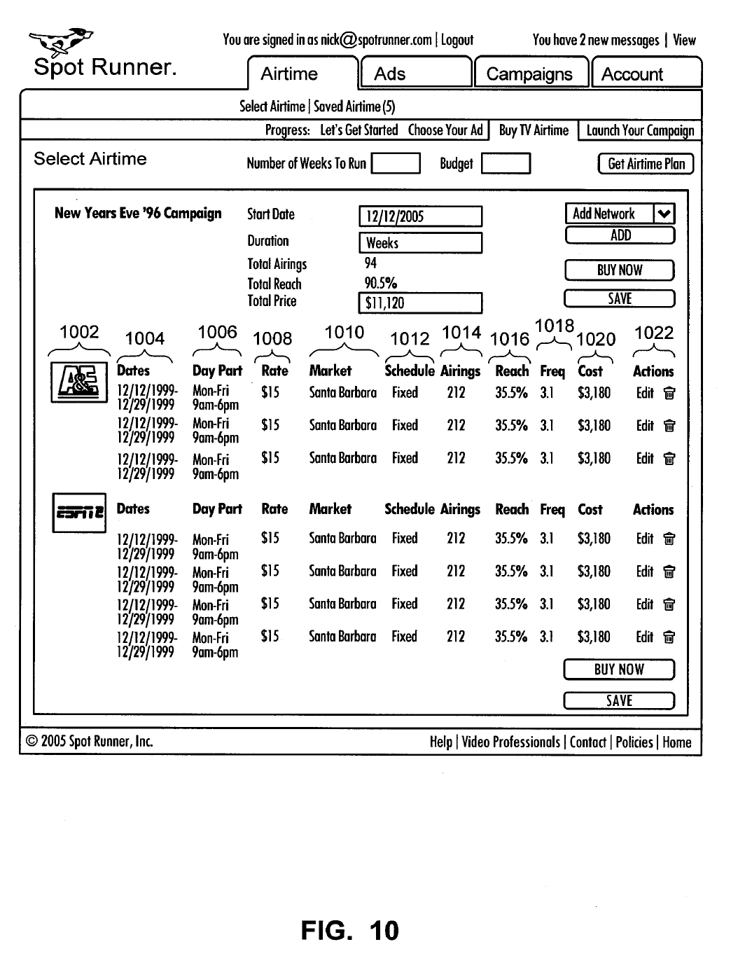

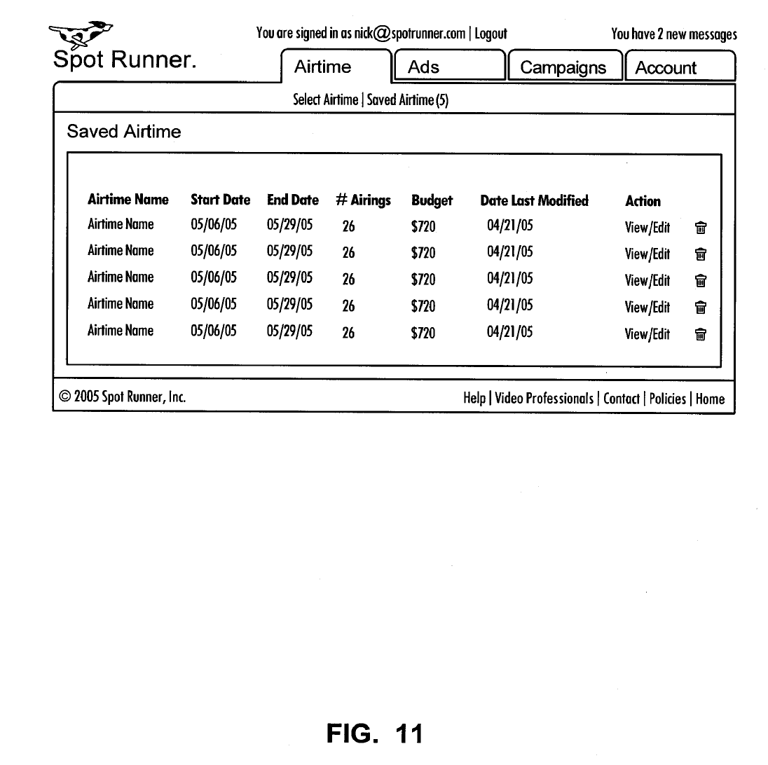

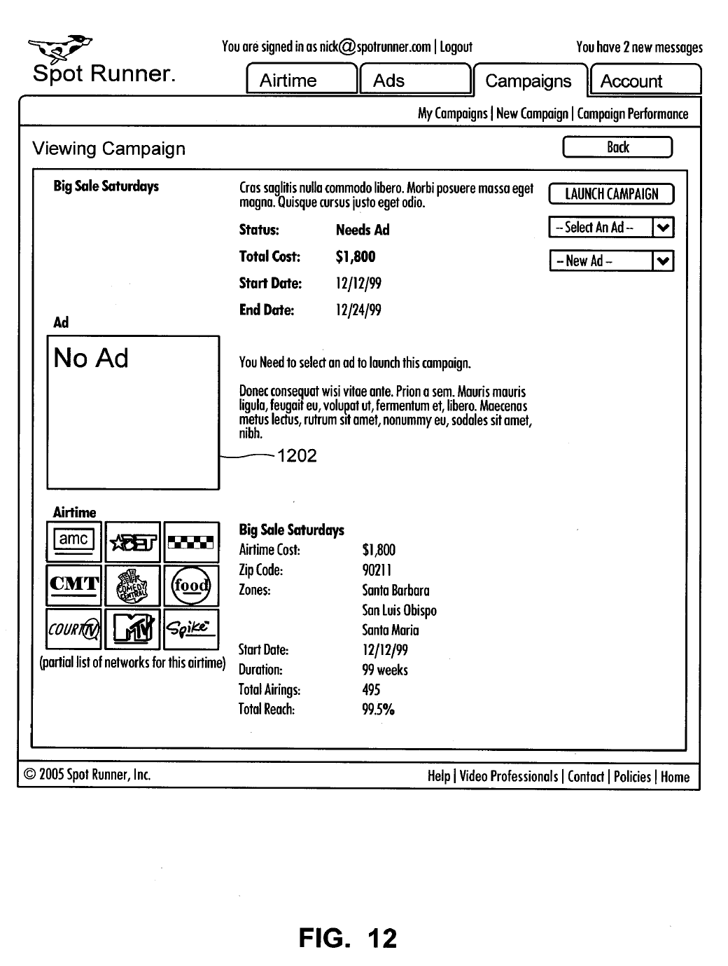

At step 404 in FIG. 4 and 504 in FIG. 5, the user is asked to select an objective and budget for the media plan. FIG. 9 shows an example web page for obtaining this information. As shown in FIG. 9, a name may be entered at 902 to identify the plan. An entry in a media plan table in advertiser info database G may be used to store the name and other information about the media plan for the particular user. The user may indicate a budget for the plan at 904, an objective for the campaign at 906, a start date for the campaign at 908 and a duration for the campaign at 910. Example objectives may include “Limited Time Event,” “Awareness,” “Response” or other objectives. The objectives maybe associated with various rules in tables in media buying rules database F. As described at 404 in box 410 of FIG. 4, computer program D uses the budget, objective and schedule to generate a recommended media schedule for the media plan. An example computer program may evaluate networks, number of spots, day parts, dates, ROS vs. Fixed placement, region or zone, reach, frequency and cost to determine a recommended plan based on rules in media buying rules database F. An example method for generating a recommended media plan is described further below. The output of this step is a recommended media plan as shown in FIG. 10. As shown in FIG. 10, the channels (at 1002), dates (at 1004), day part (at 1006), rate per airing (at 1008), market (at 1010), schedule (1012), airings (at 1014), reach (at 1016), frequency (at 1018) and cost for each entry (at 1020) may be displayed. In an alternate embodiment, frequency and reach is not displayed. Other display arrangements may also be used. The user may also edit each entry in the proposed media schedule as shown at 1022. The media plan can be saved in advertiser info database G and the user can view a list of saved plans as shown at FIG. 11. The user can select any of the plans to view them again on a screen similar to FIG. 10 or another format. FIG. 12 shows another web page for viewing a saved plan. As shown at 1202, the web page indicates that no ad has been selected for this plan. As described below, ads may be selected for placement in accordance with a plan. When an ad is selected for a plan, a thumbnail of the ad may be shown at 1202.

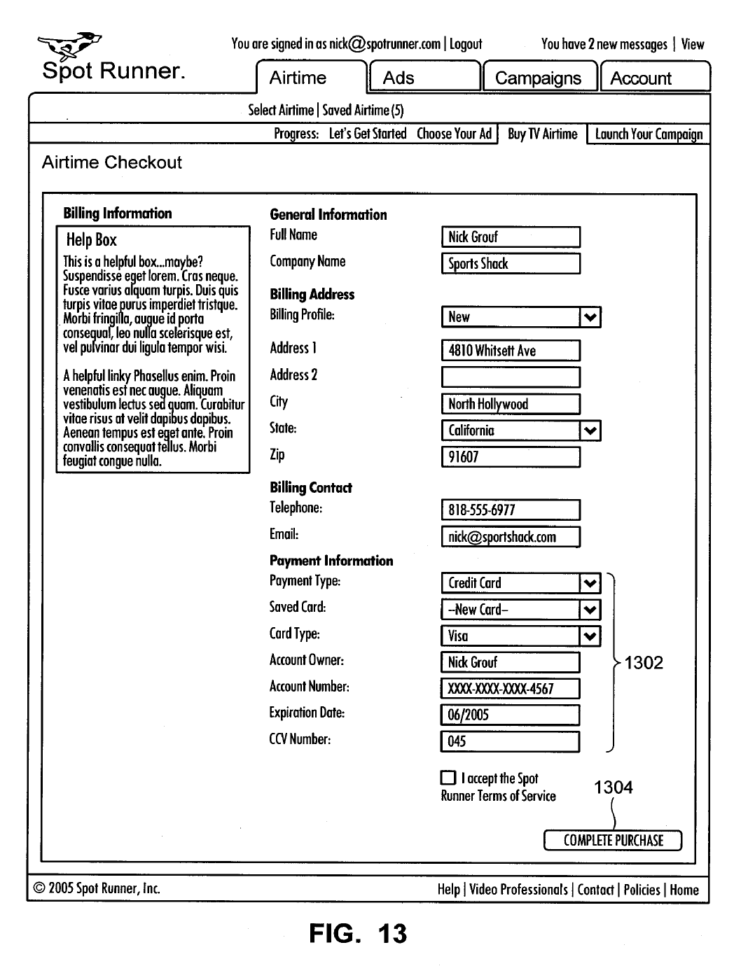

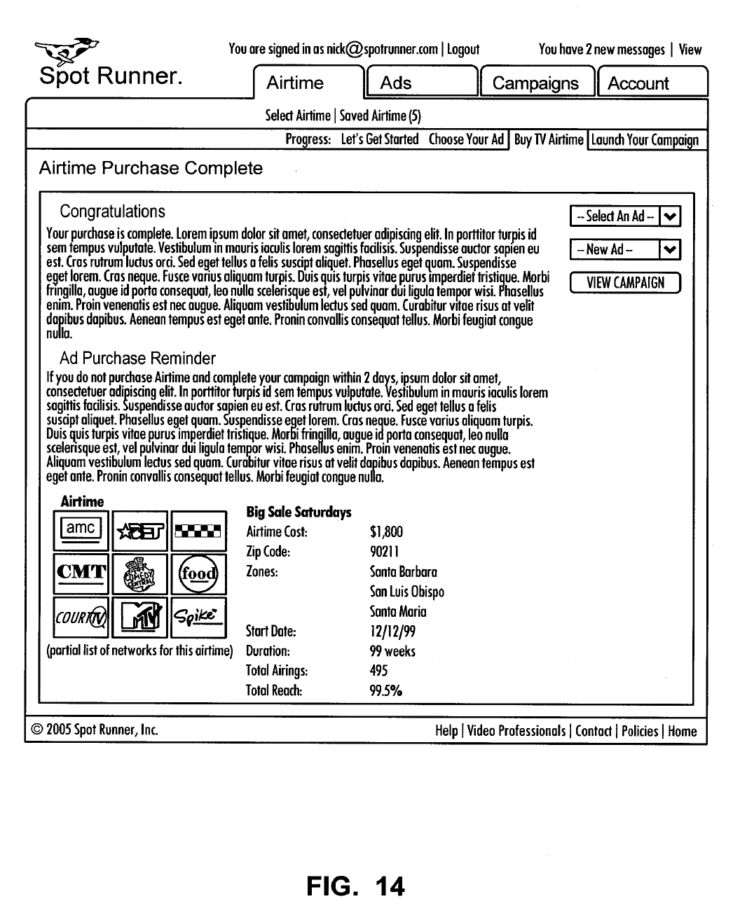

As shown at step 405 in FIG. 4 and 505 in FIG. 5, the user can then review and purchase the media plan. As shown at step 506, the user can enter billing information for the plan. An example web page for this purpose is shown in FIG. 13, where the user can enter, among other things, credit card information 1302. When the “Complete Purchase” button 1304 is selected, the user can be charged for the purchase on the specified credit card based on the total cost for the plan. A summary page (shown in FIG. 14) may be displayed after the purchase is complete showing summary information about the media plan.

The rules for submitting a media plan to an MSO or other broadcaster to purchase spots are stored in Media Buying Rules database F. For example, the format for the order (spots to be run, days/day part to run the spot, channel/network for the spot, schedule (ROS vs. Fixed), rate, total cost, etc.) and manner of submitting the order (e.g., by email, fax, web page, other network interface or other means) may be stored for each MSO. The format and other requirements for the ad and manner of submitting the ad (e.g., by email, fax, web page, other network interface or other means) may also be stored for each media property (e.g., MSO, broadcaster, publisher, web site, etc.) or distributor in Media Buying Rules database F. Once a user selects and purchases a media plan, and selects and purchases an ad to use for the media plan, the computer program can retrieve the format and transmission requirements from the Media Buying Rules database F for each media property or distributor to be used for the media plan. Then the order can be placed, and the ad can be submitted, to each respective media property or distributor in accordance with the particular rules (e.g., format and transmission rules) for that distributor or media property that were retrieved from the Media Buying Rules database F.

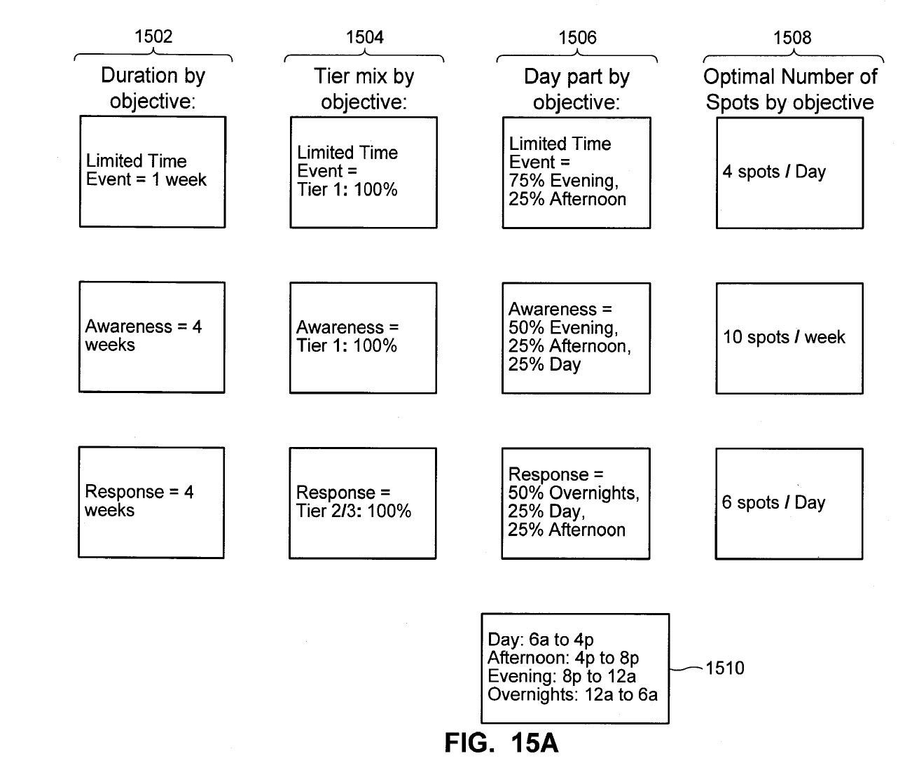

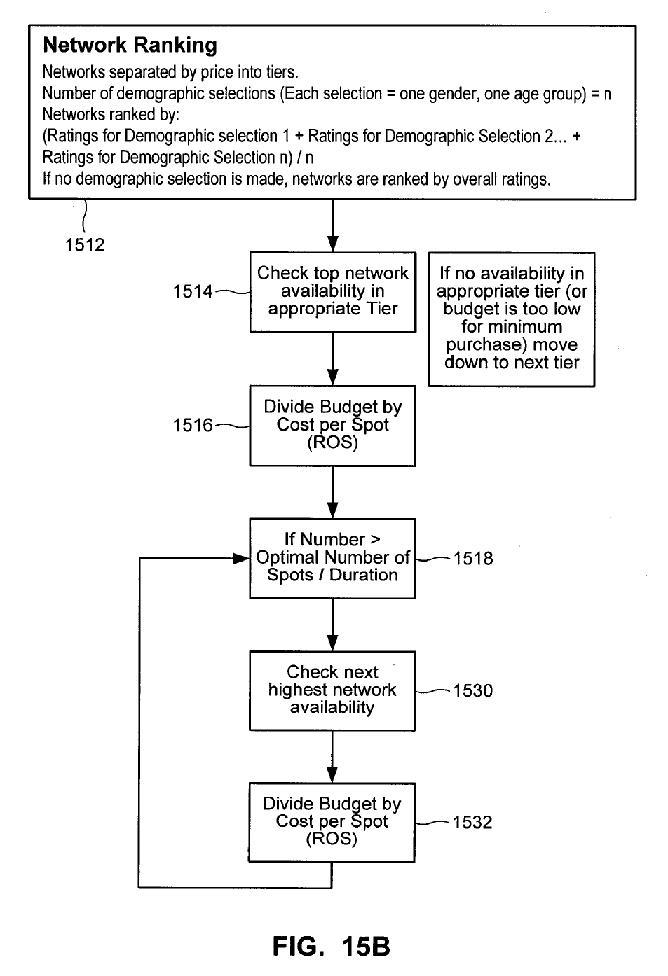

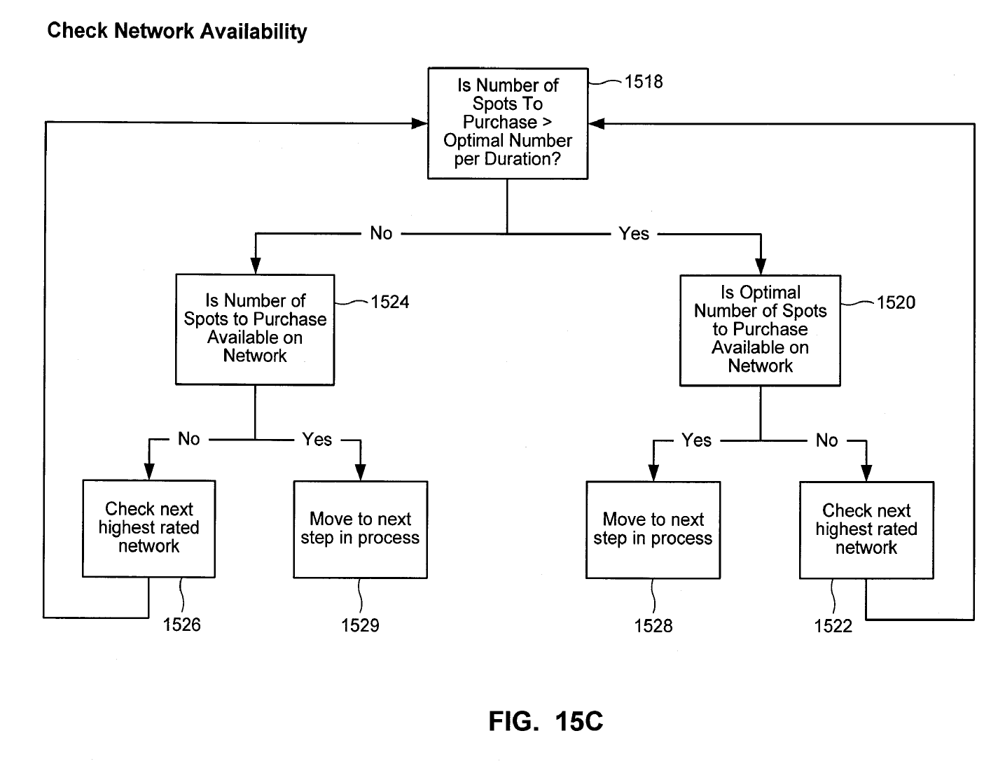

FIGS. 15A, B and C show additional information regarding an example method for generating a recommended media plan. As shown in FIG. 15A, the objective for a media plan is associated with parameters for use in generating a media plan. These parameters are stored in media buying rules database F and are associated with each respective objective type. As shown at 1502, a recommended duration is specified for each objective (although the user can specify a different duration in some embodiments, as described above). As shown at 1504 a tier mix may also be specified by objective. The higher tiers will have premium channels that cost more per spot (specified in the rate card). As shown at 1506, each objective may also be associated with a recommended “day part” specifying the time of the day that the spots should run (e.g., day, afternoon, evening, overnight as shown at 1510). As shown at 1508, an optimal number of spots (e.g., frequency per day or week) is also associated with each objective.

As described above in connection with step 403 in FIG. 4, the computer program ranks networks and generates a custom network hierarchy in order to determine a recommended media plan. This is further described at 1512 in FIG. 5B. As shown at 1512, the networks are separated by price into tiers (based on all available media properties as determined at step 402). The number of target demographics, n, is determined (each selection equals one gender and age group in this example embodiment). The networks are ranked by summing the respective audience information (such as ratings) for each demographic and dividing the total by the total number of target demographics, n. If no demographics are selected, then the networks are ranked by audience information (such as ratings, for example overall ratings). At 1514, the computer program then checks the availability of the top ranked network in the appropriate tier. The budget is then divided by the cost per spot (in this embodiment, the default rate used is the ROS rate) at 1516. At step 1518, the computer program determines whether the number of spots within the budget is greater than the optimal number of spots over the duration (both of which are determined by the objective as shown in FIG. 15A). Additional steps taken in connection with step 1518 are shown in FIG. 15C. If the number of spots is greater than the optimal number, then the computer program determines whether the optimum number of spots are available on the network at step 1520. The availability for each network is stored in media buying rules database F (shown in FIG. 4). If yes, then those spots are included in the media plan and the method continues to step 1530 (in FIG. 15B). If not, then the next highest ranking available network is checked as shown at 1522. If the number of spots is less than optimum, then the computer program determines if the number of spots is available at 1524 and either moves to the next step in the process or checks the next highest ranked network as shown at 1526. At steps 1528 and 1529, the method then continues to step 1530 (FIG. 15B) and the next available network is checked and the remaining budget is divided by the cost per spot at 1532. The method then iterates back to step 1518 and continues until the budget is exhausted (or until some other threshold is achieved).

The following is a further description of the process for generating a recommended media plan in accordance with another example embodiment. The computer program takes the following as inputs for determining the recommended media plan:

1) A list of regions in which to advertise

2) A list of desired demographic ranges

3) A time period over which to advertise

4) The objective of the campaign

The result is a list of available dayparts that match these inputs. The objective defines a number of constants for the formula, namely:

1) The default duration of the campaign

2) The budget division amongst tiers

3) The division of ads between parts of a day (day, afternoon, evening and overnight)

4) The optimal number of spots to run per week

An example method for suggesting dayparts includes the following steps:

1) Retrieve all the ratecard schedules which are tied to Local Channels in the requested regions from the media placement database, as well as the associated demographic data and any sellable date parts connected to said ratecard schedules.

2) For each schedule, find the average audience for the requested demographics per half hour, then divide by the price per spot to get a raw score per schedule

3) Divide the schedules up by tiers and allocate the budget by the objective of the campaign.

4) Within each tier, divide the schedules into buckets based on time of day, and allocate budgets according to the ratios determined by the campaign objective.

5) Order the schedules by their raw scores, and round them such that multiple schedules have the same score.

6) Reorder schedules with the same score either randomly, or based on their availability.

7) Pick the best scoring channel in any bucket, and find the schedules for the same channel in the other buckets. Allocate the number of ads defined by the optimum number for the campaign objective to the schedules according to the ratio defined by the campaign objective. Once allocated, remove the schedules from the buckets and repeat until the budget is exhausted. If the computer program cannot allocate ads on the network to hit the optimum network (either due to availability or budget constraints), move to the next network.

8) If the computer program cannot allocate ads on any channels to meet the optimum or otherwise specified number, shrink the campaign duration and try again.

9) Once the budget is exhausted, retrieve the allocated spot bookings, associated day parts and run counts and display them to the user as part of the recommended media plan.

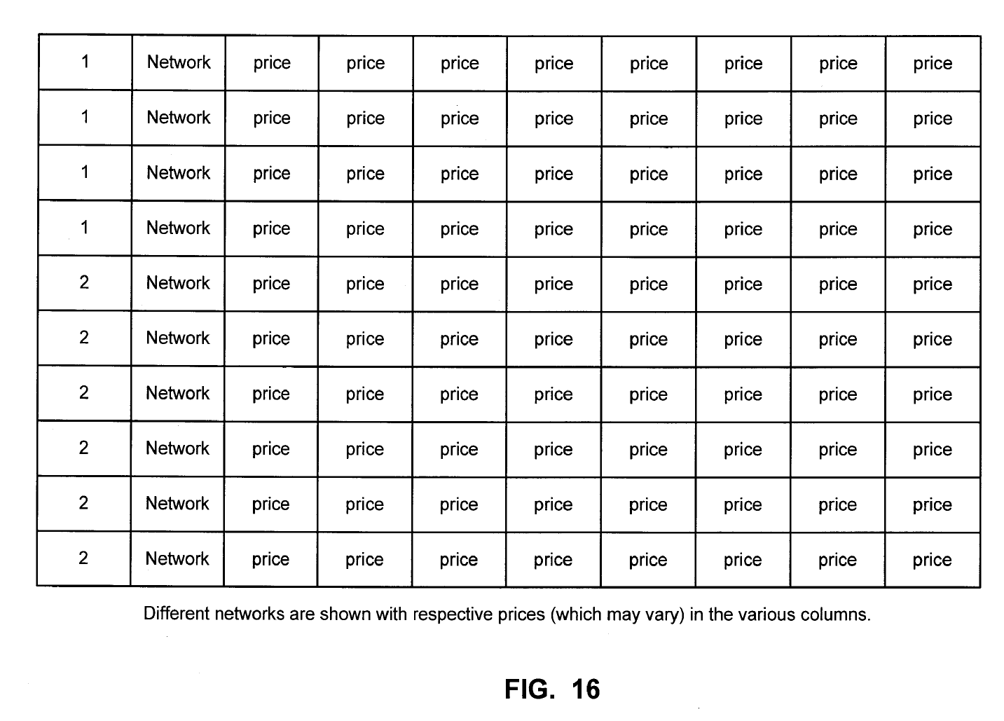

FIG. 16 shows an example rate card that may be stored in media placement database E and used in connection with the above methods.

In addition to the aspects discussed above, FIG. 5 shows steps for generating and purchasing a customized ad. A user is able to create a customized ad from a template of an ad based on a technical approach of forming customized media sequences based on media templates as described herein. The templates may take various forms adapted for various forms of media including television, radio, Internet, print, out-of-home, or other media according to various embodiments.

The templates are customized with additional media objects or information provided by the user. The media templates may include video objects, audio objects, image objects and text objects as well as an edit decision list (EDL) indicating the timeline for playing/displaying each object in the media sequence. Media editing software may be used to compile the media objects into a media file, such as a Windows Media Player or Quicktime file. The user can play the media file from a web page to view the media sequence with generic information (e.g., in the case that the media sequence is an ad, the generic information may be generic store name, voiceover etc.). Dialog boxes may be displayed to the user for elements of the template that may be customized, such as all or a portion of a voiceover, background music, text, logo, or other video objects, audio objects, image objects or text objects that are played during a portion of the media sequence. The user may type new text for the customizable part of the voiceover, or select or upload other custom media objects for use in the media sequence. The template is then tailored as indicated at O in FIG. 1, which may be a combination of automated and manual processes. For instance, a new image may automatically be loaded and inserted into the EDL to be displayed during a desired portion of a media sequence or a new voice over may be manually recorded for the text input by the user. After all of the customized media objects are created or uploaded, the customized media sequence is compiled in accordance with the EDL and sent (via email, web page or other means) to a third party (such as an advertiser) for approval.

For example, in an embodiment with an Internet advertisement, the template may include a preexisting rich media on-line advertisement or other template for creating a customized advertisement. The user can play the ad template from the web page M to view and/or hear the ad with generic information (e.g., generic store name, voiceover, etc.). In the case of e-mail advertisements, according to various embodiments, the user can peruse e-mail addresses and other information as may be permissible. In the case of static on-line ads (some banner ads, pop-up ads, etc.), according to various embodiments, the user can view the static on-line ad. Dialog boxes may be displayed to the user for elements of the ad template that may be customized. The ad template is then tailored as indicated at O in FIG. 1, which may be a combination of automated and manual processes. The customized ad is compiled and sent to the advertiser for approval (via email, web page or other means).

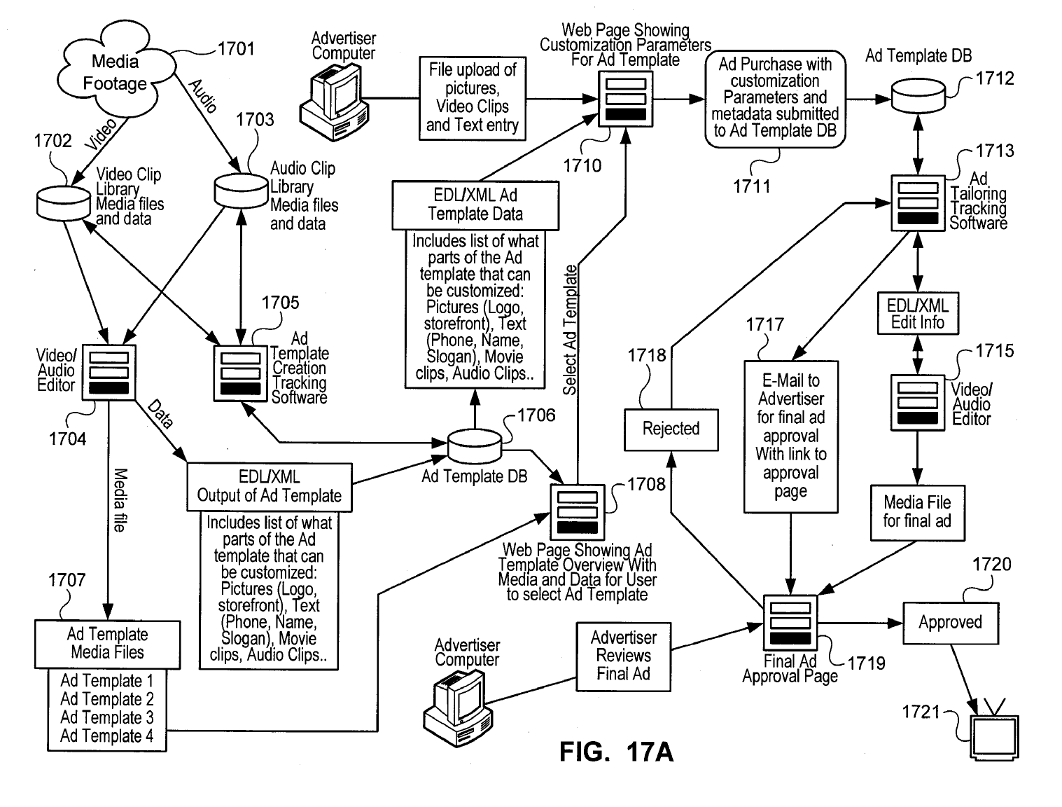

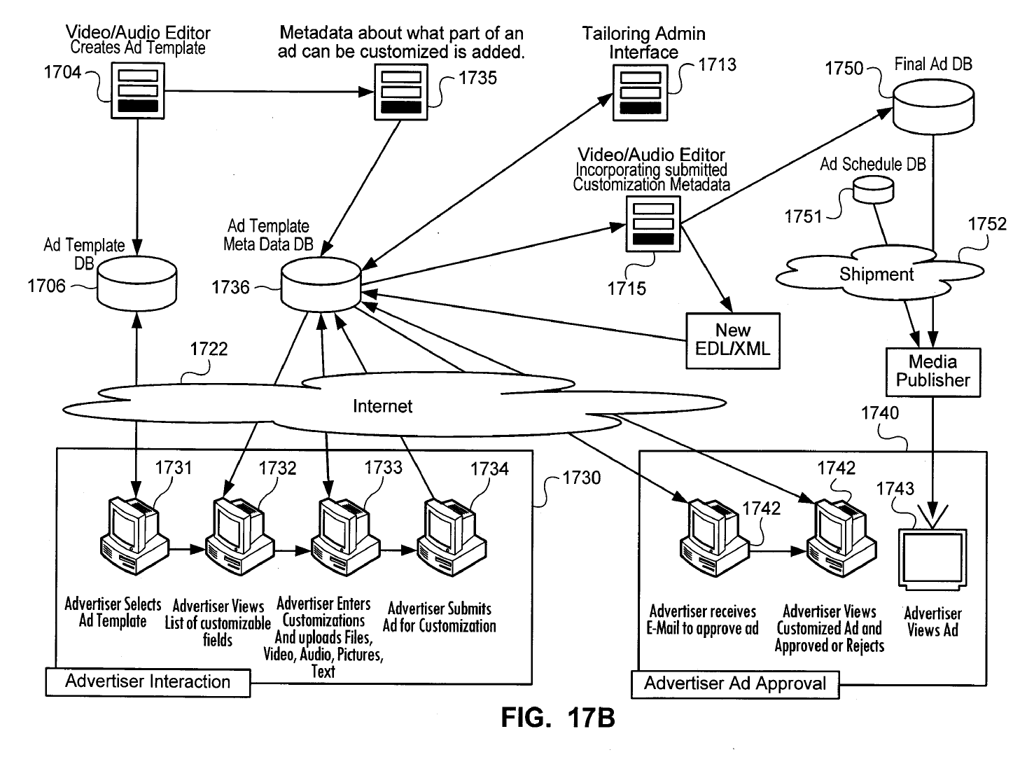

FIG. 17-A shows a system for assembling multimedia sequences into a customized multimedia sequence for play over a transmission network. Media templates are stored in a database. The templates are played for a user, and the user is prompted to provide custom information. The custom information is received from the user and combined with the template for later play as a customized media sequence.

As shown in FIG. 17-A, from media footage 1701, video clips are stored in video clip library 1702 and audio clips are stored in audio clip library. Video/audio editing software 1704 processes media objects such as video and/or audio clips from the libraries 1702 and 1703 and provides template media sequences 1707 for play. The templates are converted into a format that can be played by a user, such as Quicktime or Windows Media Player. These templates are then stored to provide access to external users for preview. The templates are stored on a web server according to one embodiment of the invention.

FIG. 17-B shows use of metadata to help in customizing media sequences (such as ads). Each ad template may be stored within a project. Each project may include metadata 1735. Metadata 1735 comprises data that describes which pieces of a template may be changed by the advertiser. The metadata may include, either individually or in various combinations: (1) text describing advertiser name, location, slogan, phone number or any other text that may vary from advertiser to advertiser; (2) images like logos, storefront pictures, merchandise pictures; (3) video of merchandise, store or other moving picture footage relevant to ad and/or (4) audio pieces used for the ad, including voices, background sounds, music, and other audio or content. By providing some or all of these the user (advertiser in the case of an ad) may change the appearance of the original template and create a customized version.

The metadata may also be stored in other ways associated with the respective template and/or customized media sequence or ad other than projects. Within the project that describes the ad template there are extra tags (non visible clips) embedded to determine what parts of the original ad are customizable. The elements are tagged by adding a leading character (#) to the naming of the element. The name of the element is used as the label describing to the advertiser what this element represents. In addition, two more fields are used to describe the default content of the element and a help string telling the user how to utilize the element.

The database and computer program will recognize these elements and make them available to the advertiser via web pages 1730 for customization. On the public webpages the elements may be sorted chronologically according to when they appear in the advertisement to make it easier on the user to perform the customization. Thus, the user selects a template 1731 and views the list of customizable fields 1732. If the element is text, the page will display an edit box to collect the information 1733. If the element is an image, audio or video, an upload dialog will be displayed 1733. The user then submits 1734 the sequence for further processing to produce a customized sequence customized in accordance with the user's inputs.

After the user interaction is complete and the provided information is verified by the advertiser, the ad is submitted for processing by the tailoring process. A revised EDL is provided to video/audio editor 1715 and new object (such as one EDL and/or XML) is provided incorporating the submitted customization metadata. In this process the tagged elements the advertiser has chosen to replace are substituted for the provided information, and the media sequence template (such as an ad template) is saved as a final ad ready for publication (for example in final database 1750). The media sequence is provided over an appropriate medium 1752 (such as a network) to a transmission network or publisher for display to third parties or for view by the user 1743.

According to an embodiment of the invention, the templates are transmitted over a network such as the Internet to be played on a remote user's computer so that the user can view the media file of the template and input appropriate custom information. The various displays for the user shown are integrated with and controlled by the web server according to an embodiment of the invention. The system plays the template media sequences over a user interface such as web page 1708. The user interface may include a media player that plays the template media sequences. The system prompts the user to provide custom information. The system includes software that prompts the user to provide the respective custom content/information 1710. This information, such as custom image data provided by the user, is then uploaded by way of the web server to a database on the system.

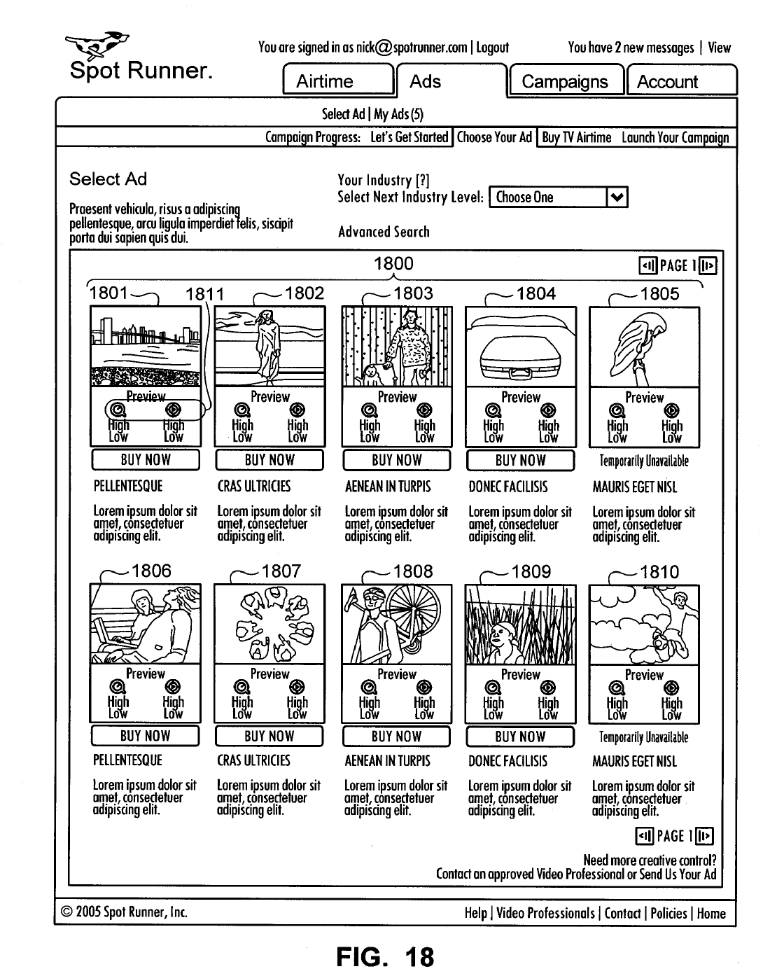

As shown in FIG. 18, an embodiment of the web server includes software that causes the user's system to display a set of different templates 1800 among which the user can select one or more for customization and/or purchase. Templates 1800 are represented by icons 1801-1801, which may display an image from the respective template. The user may select a template for play, such as by clicking on an area 1811 of template 1801. Metadata is used to associate templates with their respective icons, titles, description, and other identifying characteristics. An embodiment of the system uses such metadata to enable users to search and display templates by specific criteria.

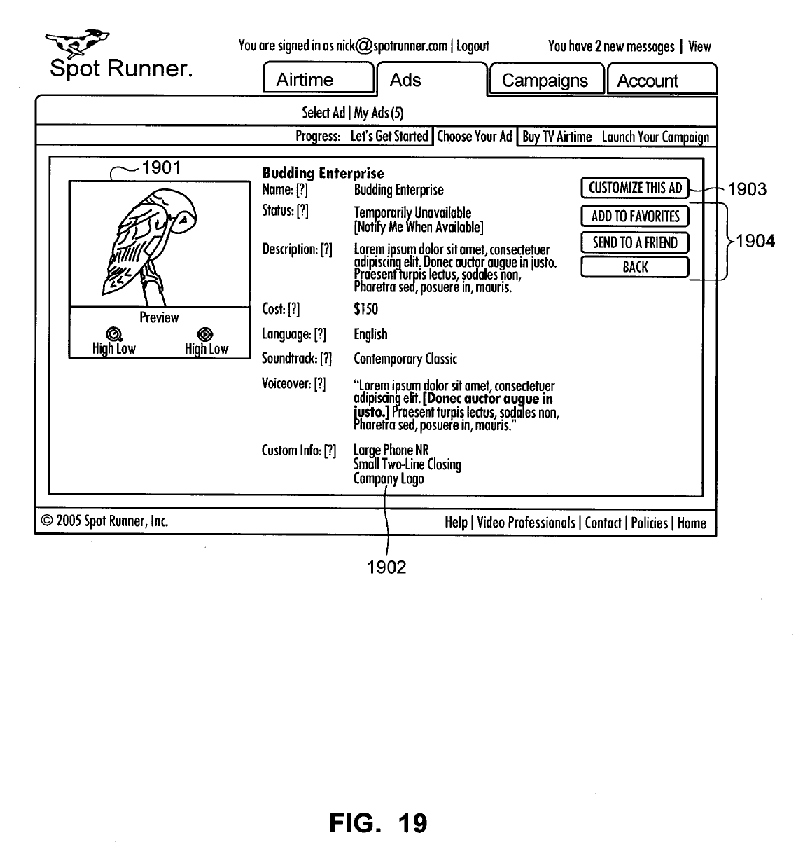

As shown in FIG. 19, the system includes software that causes the user's system to display additional information regarding the respective template media sequence. The software may cause the user's system to display an image from the template 1901 and information regarding the template 1902. The software allows the user to elect to customize the template 1903 and take various actions 1904 on the template, such as adding it to favorites or sending the template by email or other transmission.

The template media sequence is combined with information provided by the user in order to create a custom multimedia sequence. According to an embodiment, the template is stored in a format consisting of objects that include an EDL that specifies which video, audio, and image objects are combined to form the multimedia sequence that will play. The template also includes metadata that specifies aspects of the sequence defined by the EDL that can be customized. This metadata is used to define which dialog boxes should be displayed to the user to prompt the user to provide custom information.

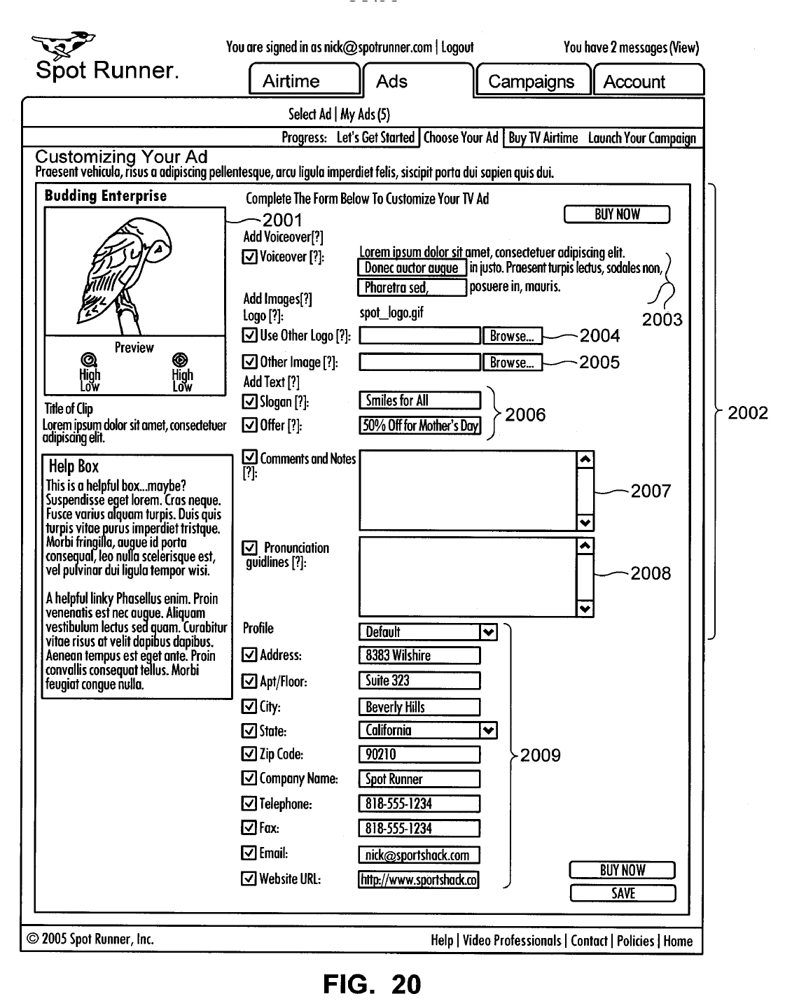

As shown in FIG. 20, the system includes software that prompts the user to customize the template. Image 2001 is from the template. Inputs 2002 allow the user to provide custom information that can be combined with the template to create a custom media sequence. For example, the system includes software to allow the user to provide various combinations of voiceover (2003), logos (2004), other images (2005), text (2006), comments and notes (2007), guide to pronunciation (2008), and/or other custom information/objects. Profile data 2009 regarding the user is collected and associated with the custom media sequence.

The system provides the user the option to purchase the respective customized sequence (for example, where the sequence is an advertisement, the user is provided the option to purchase the custom advertisement). Software provides a user interface to allow the user to make the purchase, as shown at 1711.

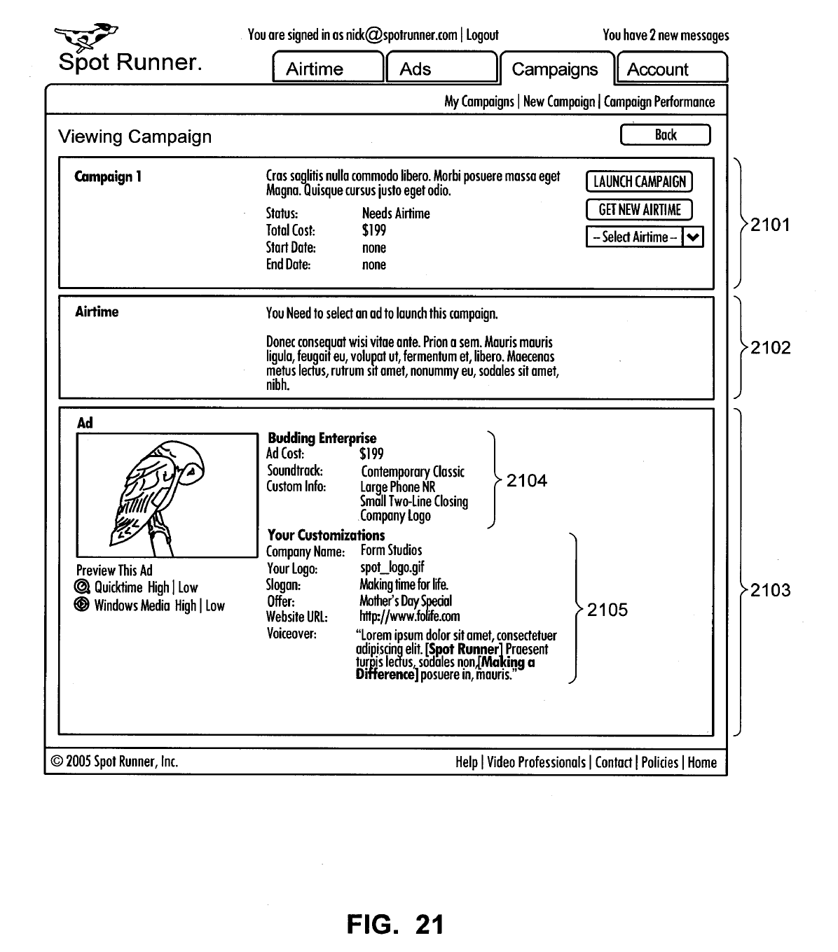

As shown in FIG. 21, an embodiment of the system includes software to display information about sets of media sequences, such as a campaign of advertisements. The information may include overall information 2101 regarding the campaign, information regarding airtime 2102, and information about the respective media sequence, which may comprise a customized or other advertisement 2103. For example, where the sequence is a customized advertisement, the system shows general information (2104) about the advertisement as well as information about the customization (2105).

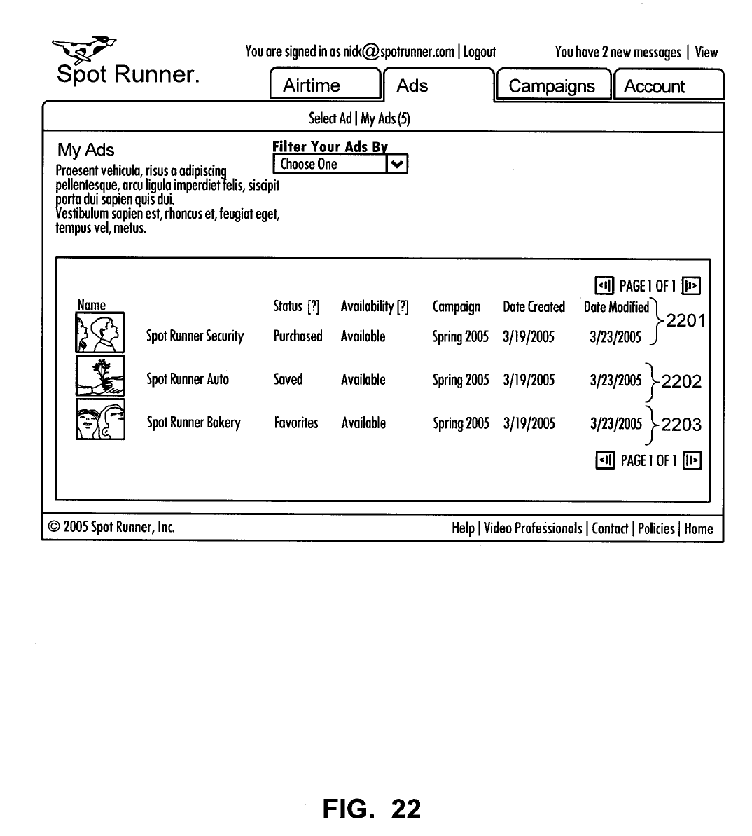

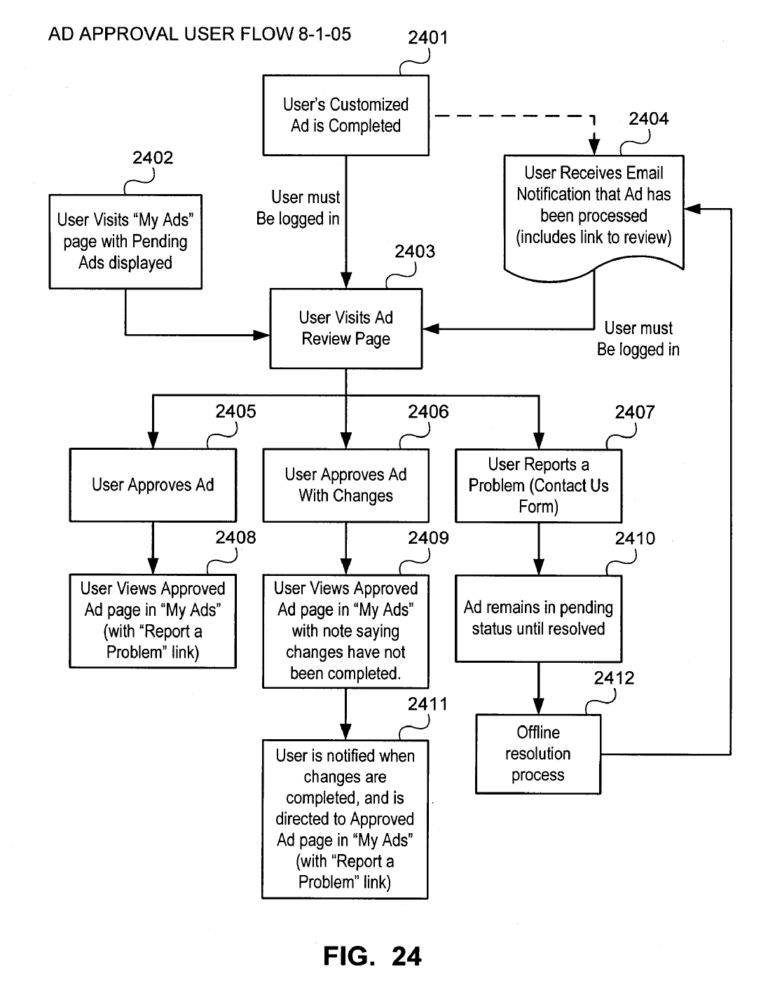

As shown in FIG. 22, an embodiment of the system also includes software that summarizes media sequences (such as advertisements) associated with the user. For example in the case of advertisements, the system shows the set of advertisements 2201-2202 that have been selected and/or purchased by the user. Information about each media sequence (e.g., advertisement) may be displayed in column or other format. As shown in FIG. 24, the system includes software that allows the user to approve respective advertisements. After the user's customized advertisement is completed 2401, the user receives an email notification 2404. The user visits an ad review page 2403, which may be preceded by completing the customized ad 2404 or the user visiting a page with a summary of pending ads 2404. The user may approve the ad 2405, approve the ad with changes 2406 or report a problem 2407. After approving the ad, the user may view the approved ad 2480. After approving the ad with changes, the user may view the approved ad page with an indication that the changes have not been completed 2409, and the user is notified when the changes are completed 2411. When the user reports a problem 2407, the ad remains in pending status 2410 and a resolution process is executed 2412, which may be offline or automatic according to various implementations.

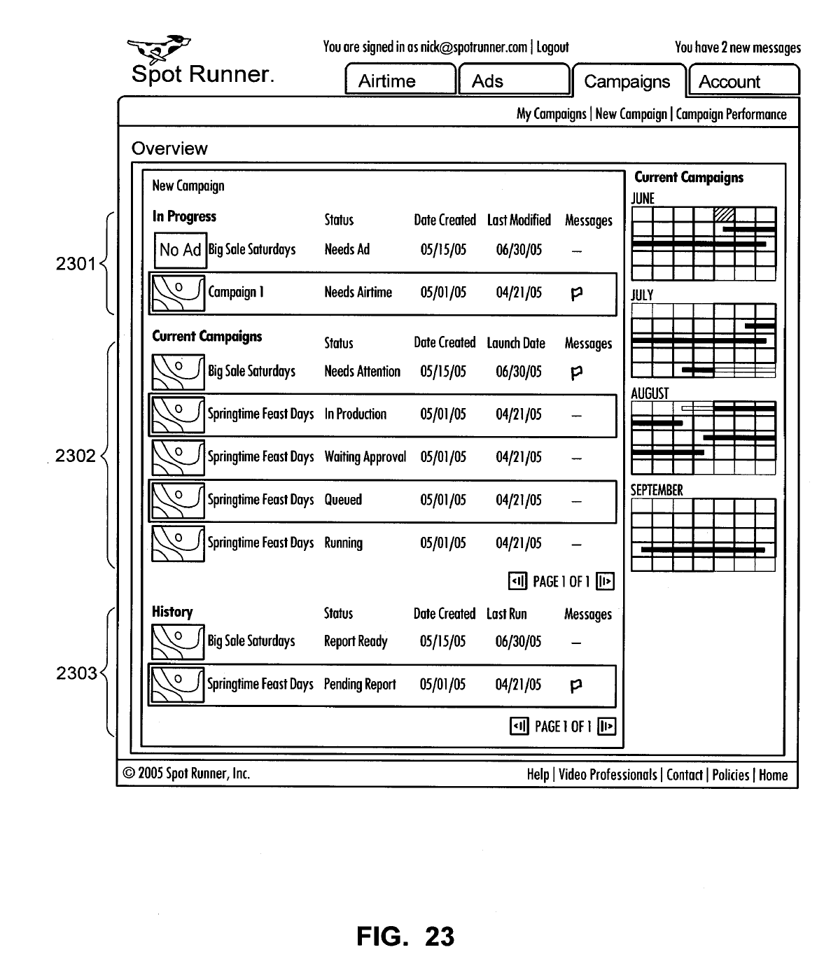

As shown in FIG. 23, an embodiment of the system also includes software that summarizes groupings of sets of media sequences. For example, in the case of advertisements, the groups may be campaigns. Summary information 2301 shows campaigns in progress, summary information 2302 shows current campaigns, and summary information 2303 shows history.

A custom media sequence may be formed based on the custom information provided by the user in a software component such as tailoring tracking software 1713 and video/audio editor 1715, which use templates from template database 1712. The customized media sequence (such as a custom advertisement) is provided to the user (such as an advertiser) by electronic transmission (such as by email) 1717. The media sequence may be provided in a final form 1717 for display and final approval (displayed through an interface 1719). The media sequence is then transmitted to a transmission network for display and/or play on other systems 1721, such as by broadcast to viewers of a cable television network.

According to one embodiment of the invention, the templates are stored separately from the respective custom user data. At a time when the integrated multimedia sequence is to be played, the template and custom user data are provided to the transmission network and are assembled into an integrated multimedia sequence in the transmission network and broadcast to viewers.

Referring again to FIG. 5, a user may select and purchase advertisements. The system provides software to allow the user to select an advertisement 520. To purchase the advertisement, the system prompts the user for and obtains personal information 524 and then provides the user a confirmation 525 and purchase receipt 526. The system prompts the user for the user's budget 527, and allows the user to review and/or purchase a respective media plan 528. The system provides the user the option to create a new advertisement and/or search advertisements 521. The system provides detailed information regarding the advertisement 522 and based on user inputs customizes the advertisement 523. The resulting advertisement is then associated with the user and is displayed in a corresponding page 529. The above sequence may be applied generally to media sequences that are not necessarily advertisements, allowing a user to purchase, customize and/or store the respective sequence.

According to an embodiment of the invention, the system includes software that automatically calculates royalties for content used in media sequences based on usage. The sum of the content has an associated percentage of revenue that is received for all content in the sequence. The royalties paid for a particular portion of content is calculated based on the percentage of time in the sequence that the particular portion of content is run, so that the amount of royalties received for a particular portion of content is a prorated portion of the royalties received for all content based on playtime. For example in the case of an advertisement, the royalties for all content may be X% of revenue. For a particular portion of content, its royalties may be based on the X% times a percentage of time that the portion is run. The royalties may be multiplied by other factors and/or ratios to appropriately apportion royalties between various portions of content. For example, where there are various video, audio and image portions of content that are run simultaneously, royalties may be apportioned based on time run and other factors. The associated factors may be stored in an appropriate database, such as asset/royalty database I.

Various levels of exclusivity may be granted to various users of content in the system. The exclusivity may be geographic and/or temporal. For example, in one embodiment, when a user purchases an advertisement based on a particular template, the user may be granted some form of exclusivity for the template. In one example, when a user purchases a template, the user is automatically granted exclusivity in a geographic market (for example, a city or metropolitan area, or a state) for the respective template, for a particular time (for example, one month, 3 months, 6 months, 1 year).

Aspects of the systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the systems and methods include: microcontrollers with memory, embedded microprocessors, firmware, software, etc. Furthermore, aspects of the systems and methods may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that the various functions or processes disclosed herein may be described as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.). When received within a computer system via one or more computer-readable media, such data and/or instruction-based expressions of components and/or processes under the systems and methods may be processed by a processing entity (e.g., one or more processors) within the computer system in conjunction with execution of one or more other computer programs.

Unless the context clearly requires otherwise, throughout the description and the claims, the words ‘comprise,’ ‘comprising,’ and the like are to be construed in an inclusive sense as opposed to an exclusive or exhaustive sense; that is to say, in a sense of ‘including, but not limited to.’ Words using the singular or plural number also include the plural or singular number respectively. Additionally, the words ‘herein,’ ‘hereunder,’ ‘above,’ ‘below,’ and words of similar import refer to this application as a whole and not to any particular portions of this application. When the word ‘or’ is used in reference to a list of two or more items, that word covers all of the following interpretations of the word: any of the items in the list, all of the items in the list and any combination of the items in the list.

The above description of illustrated embodiments of the systems and methods is not intended to be exhaustive or to limit the systems and methods to the precise form disclosed. While specific embodiments of, and examples for, the systems and methods are described herein for illustrative purposes, various equivalent modifications are possible within the scope of the systems and methods, as those skilled in the relevant art will recognize. The teachings of the systems and methods provided herein can be applied to other processing systems and methods, not only for the systems and methods described above.

The elements and acts of the various embodiments described above can be combined to provide further embodiments. These and other changes can be made to the systems and methods in light of the above detailed description.

In general, in the following claims, the terms used should not be construed to limit the systems and methods to the specific embodiments disclosed in the specification and the claims, but should be construed to include all processing systems that operate under the claims. Accordingly, the systems and methods is not limited by the disclosure, but instead the scope of the systems and methods is to be determined entirely by the claims.

While certain aspects of the systems and methods are presented below in certain claim forms, the inventors contemplate the various aspects of the systems and methods in any number of claim forms. Accordingly, the inventors reserve the right to add additional claims after filing the application to pursue such additional claim forms for other aspects of the systems and methods.

What is claimed is:

1. A computerized method of generating a on-line media plan for a on-line advertiser comprising:
storing information regarding advertising rates of a plurality of on-line media properties;
storing information regarding on-line audience reached by the on-line media properties;
storing information regarding the on-line advertiser;
generating a media plan for on-line advertisements based on the advertising rates, information regarding on-line audience, the information regarding the on-line advertiser; and
presenting the media plan to the on-line advertiser for purchase.

2. The method of claim 1, wherein the on-line advertisement includes an advertisement placed on a web site.

3. The method of claim 1, wherein the on-line advertisement includes an advertisement sent by e-mail.

4. The method of claim 1, wherein the on-line advertisement includes a rich media advertisement.

5. The method of claim 1, wherein the on-line advertisement includes a click-through advertisement.

6. The method of claim 1, wherein the media plan includes at least a web site on which the on-line advertisements will run.

7. The method of claim 1, wherein the media plan includes an identification of e-mail addresses to which the on-line advertisements will be sent.

8. The method of claim 1, wherein the media plan includes a list of dates the on-line advertisements will run.

9. The method of claim 1, including storing information regarding a plurality of channels of on-line advertising including e-mail and web sites, and generating the media plan based on the stored information.

10. The method of claim 1, including storing measurement information for the forms of on-line advertising and generating the media plan based on this measurement information.

11. The method of claim 1, including generating the media plan including e-mail, banner, rich media, and pop-up forms of advertisements.

12. The method of claim 1, including selecting a form of on-line advertising reaching a target demographic allowing a desired number of advertisements to be purchased within a specified budget.

13. The method of claim 1, wherein the information regarding audience comprises demographic information.

14. The method of claim 1, including generating the on-line media plan based on the audience information including a combination of audiences' leisure interests, use of technology, brand preferences, and amounts spent on different products and services.

15. The method of claim 1, including sending at least a part of the media plan to an on-line media property.

16. The method of claim 1, including ranking on-line media properties by summing respective audience information for each demographic and dividing by a total number of demographics, and, if no demographics are selected, ranking on-line networks by audience information.

17. The method of claim 1, including measuring efficacy of the on-line advertising on the advertiser's own web site.

18. The method of claim 1, wherein measuring efficacy of the on-line advertising on the advertiser's own web site comprises measuring number of visitors on the advertiser's own web site.

19. The method of claim 1, wherein measuring efficacy of the on-line advertising on the advertiser's own web site comprises measuring transactions the advertiser achieves from viewers clicking on a link in an advertisement.

20. A system for providing an on-line media plan for a on-line advertiser comprising:
a database of rate information of a plurality of on-line media properties;
a database of information regarding performance of the on-line media properties for respective demographics;
an interface that prompts a on-line advertiser for information regarding at least an audience targeted by the advertiser;
logic that generates a on-line media plan based on the rate card, information regarding performance, the demographic and the budget; and
an interface that presents the plan to the on-line advertiser for purchase.

21. The system of claim 20, wherein the interface obtains a budget from the on-line advertiser.

22. A method for providing a media plan for a on-line advertiser comprising:
receiving location data from the on-line advertiser and, based on the location information and a database that associates location information, determining available markets;
receiving market selection from the on-line advertiser and, based on a database including rate information of on-line media properties, determining viable on-line media properties;
receiving selection of business category or demographics, performing category matching, and determining a custom on-line network hierarchy; and
receiving campaign parameters and, based on the campaign parameters, generating an on-line media plan.

23. The method of claim 22, wherein the campaign parameters include budget, media objectives and media schedule.

24. The method of claim 22, including:
storing the media plan in a database for the on-line advertiser;
allowing the on-line advertiser to view a list of saved plans; and
displaying a plan selected by the on-line advertiser.

25. The method of claim 22, including successively checking available on-line networks, determining remaining available budget until budget is exhausted, and including the on-line networks in the plan if budget is available.
